(19) United States
(12) Patent Application Publication
(10) Pub. No.: US 2018/0036870 A1
(43) Pub. Date: Feb. 8, 2018

(54) DRIVING MACHINE

(71) Applicant: Hitachi Koki Co., Ltd., TOKYO (JP)

(72) Inventors: Yoshiichi KOMAZAKI, IBARAKI (JP); Mayumi UMINO, IBARAKI (JP); Yuki MITOMA, IBARAKI (JP); Shinichirou SATO, IBARAKI (JP)

(73) Assignee: Hitachi Koki Co., Ltd., TOKYO (JP)

(21) Appl. No.: 15/551,041

(22) PCT Filed: Feb. 19, 2016
(86) PCT No.: PCT/JP2016/054905

§ 371 Date: Aug. 15, 2017

(30) Foreign Application Priority Data
Feb. 26, 2015 (JP) 2015-037416
Sep. 26, 2015 (JP) 2015-189060

(51) Int. Cl. B25C 1/04; B25C 1/06

(52) U.S. Cl. CPC B25C 1/047; B25C 1/06

(57) ABSTRACT

A driving machine capable of performing replenishment of air in a pneumatic chamber includes: a housing; a cylinder provided within the housing; a pneumatic chamber spatially connected to the cylinder; a piston reciprocally movably provided in the cylinder; a blade attached to the piston and striking a stopper; and a moving mechanism reducing an internal volume of either the pneumatic chamber or the cylinder by a motor, and the driving machine drives the stopper by repulsive force of compressed air. The driving machine has a pressure accumulating mode in which the pneumatic chamber is pressurized by the motor from a state where the pneumatic chamber communicates with outside, and a striking mode in which the piston is moved by the motor from a bottom dead point to a top dead point in the cylinder and then from the top dead point toward the bottom dead point, thereby driving the stopper.

### BACKGROUND OF THE INVENTION

### Field of the Invention

The present invention relates to a driving machine that moves a driver blade by pressure of a gas such as air to strike a stopper.

### Description of the Related Art

Conventionally, there is known a driving machine or nailing machine that strikes a stopper by force of compressed air, wherein the driving machine is described in Patent Document 1. The driving machine described in Patent Document 1 includes: a motor provided within a housing; a gear transmitting a rotational force of the motor to a cam; a cylinder provided within the housing; a piston reciprocally movably accommodated in the cylinder; a driver blade fixed to the piston; and a bellows provided in the cylinder. The bellows is extendable, wherein a first end portion of the bellows is connected to the piston, and a second end portion of the bellows is fixed to the housing. The compressed air is sealed in the bellows to form a pressure chamber (pneumatic chamber).

In the driving machine described in Patent Document 1, when the cam is rotated by the rotational force of the motor, the piston is moved from a bottom dead point toward a top dead point by a rotational force of the cam. During movement of the piston from the bottom dead point toward the top dead point, the bellows is compressed and pressure of the pressure chamber increases. When the piston reaches the top dead point, the rotational force of the cam is no longer transmitted to the piston, and the piston is moved from the top dead point toward the bottom dead point by a force of the compressed air in the pressure chamber. As a result, the driver blade strikes the stopper. Prior-Art Documents

### PATENT DOCUMENTS

Patent Document 1: JP 2014-69289

### SUMMARY OF THE INVENTION

### Problems to be Solved by the Invention

In the driving machine described in Patent Document 1, since the air is kept sealed in the pressure chamber forming in the bellows at all times, even in cases where the stopper is not struck, it is necessary to seal the bellows. There is a fear that, as a number of times of use and duration of use of the bellows increase, the air in the bellows may gradually decrease, and a striking force is reduced.

An object of the present invention is to provide a driving machine capable of easily replenishing air in a pneumatic chamber used to strike a piston. Another object of the present invention is to provide a driving machine that perform is replenishment (pressure accumulation) of the air in the pneumatic chamber by moving the piston in an opposite direction by an electric motor. Still another object of the present invention is to provide a driving machine capable of easily discharging gases in the pneumatic chamber.

### Means for Solving the Problems

In order to achieve the above objects, a driving machine of the present invention includes: a housing; a cylinder provided within the housing; a pneumatic chamber spatially connected to the cylinder; a piston reciprocally movably provided in the cylinder; a blade attached to the piston and striking a stopper; and a moving mechanism reducing an internal volume of either the air chamber or the cylinder by a motor, and the driving machine drives the stopper by a repulsive force of compressed air, wherein the driving machine is configured to have a pressure accumulating mode in which the pneumatic chamber is pressurized by the motor from a state where the air chamber communicates with the outside, and a striking mode in which the piston is moved by the motor from a bottom dead point to a top dead point in the cylinder and then from the top dead point toward the bottom dead point, thereby driving the stopper.

### Effects of the Invention

According to the present invention, since an operator can easily increase pressure of a gas in the pneumatic chamber, a driving machine having long life and high performance can be realized without being bothered by pressure reduction in the pneumatic chamber due to longtime use. In addition, since the pressure in the pneumatic chamber can be reduced, maintainability during nail clogging or the like is considerably improved.

### BRIEF DESCRIPTION OF THE DRAWINGS

FIG. 1 is a longitudinal sectional view showing a driving machine 201 according to a first example of the present invention.

FIG. 2 is an arrow view as viewed from a direction A in FIG. 1 (when a piston 47 is at a bottom dead point).

FIG. 3 is an arrow view as viewed from the direction A in FIG. 1 (when the piston 47 is at a top dead point).

FIG. 4 is an arrow view of a nose portion 254 as viewed from a side opposite the direction A in FIG. 1.

FIG. 5 is a block circuit diagram of the driving machine 201.

FIG. 6 is a partial enlarged view (part 1) of the vicinity of an external air intake valve 260 provided in a pressure accumulation container 250 in FIG. 1.

FIG. 7 is a partial enlarged view (part 2) of the vicinity of the external air intake valve 260 provided in the pressure accumulation container 250 in FIG. 1.

FIG. 8 is a partial enlarged view (part 3) of the vicinity of the external air intake valve 260 provided in the pressure accumulation container 250 in FIG. 1.

FIG. 9 is a flowchart showing a procedure for pressurizing a pneumatic chamber 249 in a pressure accumulating mode according to examples of the present invention.

FIG. 10 is a longitudinal sectional view showing a driving machine 301 according to a second example of the present invention.

FIG. 11 is enlarged longitudinal sectional views of a leak valve 360 in FIG. 10.

FIG. 12 is a partial longitudinal sectional view showing a driving machine according to a modification of the second example of the present invention.

FIG. 13 is a front view showing a driving machine 10 according to a third example of the present invention.

FIG. 14 is a side sectional view of the driving machine 10 shown in FIG. 13.

FIG. 15 is a front sectional view (part 1) of the driving machine 10 shown in FIG. 13.

FIG. 16 is a front sectional view (part 2) of the driving machine 10 shown in FIG. 13.

FIG. 17 is a side sectional view showing a fourth example of the driving machine of the present invention.

FIG. 18 is a front sectional view of the driving machine shown in FIG. 17.

FIG. 19 is a front sectional view showing a fifth example of the driving machine of the present invention.

FIG. 20 is a side sectional view of the driving machine shown in FIG. 19.

### DESCRIPTION OF THE EMBODIMENTS

### Example 1

The driving machine 201 includes: a striking mechanism (including a cylinder 245, the pressure accumulation container 250, the piston 47, and a blade 48) striking a nail 11 being a driving object; an electric motor 13 generating power for driving the striking mechanism; a power transmission mechanism moving the blade 48 of the striking mechanism by the power of the electric motor 13; a storage battery 15 supplying electricity to the electric motor 13; and a magazine 16 supplying the nail 11 to a shooting path of the striking mechanism one at a time and holding a plurality of the shot nails 11. The nail 11 is a stopper formed by sharpening a tip of a thin round bar or square bar and widening a rear end thereof into a flange shape, and the driving machine 201 is capable of striking nails of about 50 to 110 mm. The striking mechanism is accommodated within a main body housing 202 made of synthetic resin and having a cylindrical shape. A grip 203 for being held by an operator by one hand is provided on a lateral side of the main body housing 202, and a mounting portion 204 of the storage battery 15 is provided on an end portion of the grip 203. The storage battery 15 is attachable to and detachable from the mounting portion 204. A control circuit substrate 81 for mounting a later-described controller (control portion) is accommodated in the mounting portion 204.

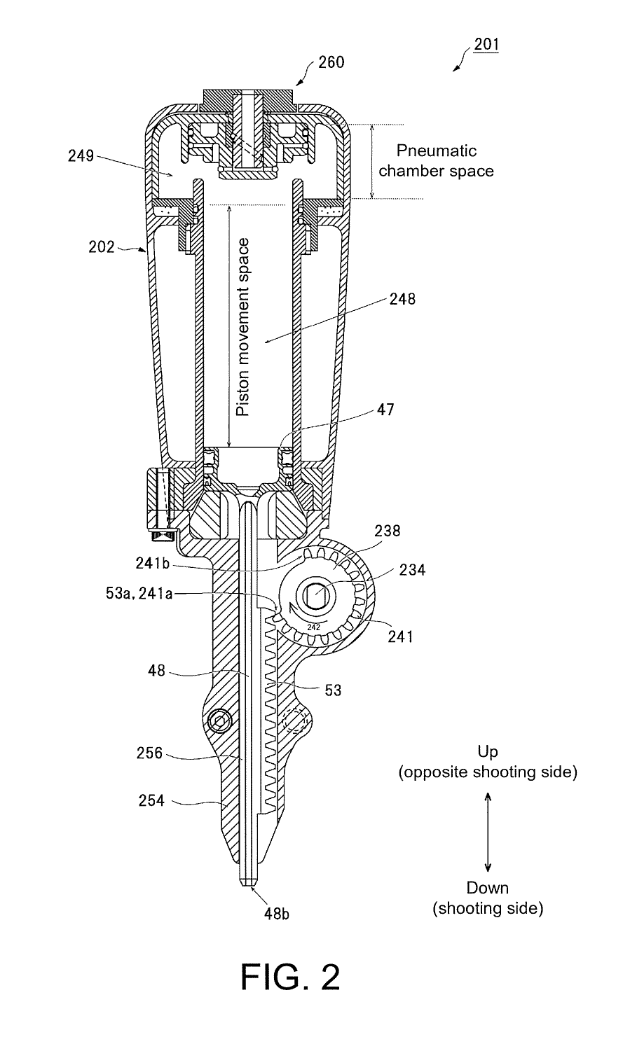

A seal member 55 is attached to an outer peripheral surface of the piston 47, and the piston 47 is reciprocally movable in the cylinder 245 in an axial direction along a center line B1. The blade 48 for driving the nail 11 and being axially elongated is fixed to a lower portion of the piston 47, and the pressure accumulation container 250 for storing air is provided on an upper portion of a space where the piston 47 moves. The pressure accumulation container 250 is formed by a container main body portion 251 having a substantial cup shape with an opening facing downward, and a flange portion 255 blocking the opening part of the container main body portion 251 and having formed therein an attaching portion for attachment to the cylindrical cylinder 245. An internal space (pneumatic chamber 249) of the pressure accumulation container 250 has the pneumatic chamber 249 that maintains the air introduced from the outside in a pressurized state, and is fluidly connected to a space (a later-described cylinder chamber 248 in FIG. 2) in which the air is compressed by the piston 47. In order to introduce the air from the outside into the pneumatic chamber 249, the external air intake valve 260 is provided on an upper portion of the pressure accumulation container 250. Details of the external air intake valve 260 are described later.

The storage battery 15 has an accommodation case and a plurality of battery cells (not illustrated) accommodated in the accommodation case. The battery cells are rechargeable and dischargeable DC secondary batteries, and may be lithium-ion batteries, nickel-hydrogen batteries, lithium-ion polymer batteries, nickel-cadmium batteries and so on. A part of the mounting portion 204 is connected to a motor housing 17 continuous with a casing 233. Herein, the main body housing 202, the grip 203, the mounting portion 204, the casing 233, and the motor housing 17 are made of a molded article made of synthetic resin such as plastic, the nose portion 254 is made of aluminum alloy or iron-based metal, and these components constitute a case part (housing in a broad sense) of the driving machine 201.

The electric motor 13 is a brushless DC motor, including a stator 18 unrotatably fixed to the motor housing 17, and a rotor 19 rotatably axially supported on an inner peripheral side of the stator 18. The stator 18 is formed by winding a coil 21 for energization around a stator core made of a laminated iron core. The rotor 19 includes an output shaft 24 supported by two bearings 82a and 82b, and a rotor core and a permanent magnet that are fixed to the output shaft 24. The output shaft 24 is rotatable about an axis line A1. A substantially annular inverter circuit substrate 83 is provided on an end portion side of the electric motor 13, and a plurality of switching elements 84 such as field-effect transistors (FETs) or insulated-gate bipolar transistors (IGBTs) that form a later-described inverter circuit are mounted thereon. In addition, a magnetic detection element (not illustrated) such as a Hall integrated circuit (IC) for detecting a rotation position of the rotor 19 is provided on the inverter circuit substrate 83.

A rotational force of the electric motor 13 is transmitted to a drive shaft 234 through a decelerator 27. A well-known speed reduction mechanism may be used as the decelerator 27. Herein, by providing a planetary gear mechanism in two-stage series, a rotational speed of the output shaft 24 is reduced to about one ten-oddth thereof, so as to rotate the drive shaft 234. A rotating body 238 is fixed to an end portion of the drive shaft 234 and rotates in synchronization with the drive shaft 234. The rotating body 238 constitutes a part of the power transmission mechanism that moves the blade 48 of the striking mechanism by the power of the electric motor 13, and configuration or operation thereof is described later in FIG. 2 to FIG. 4.

The nose portion 254 is attached to a shooting direction side of the main body housing 202, and forms the shooting path of the shot nail 11. A pushrod 104 is provided on the nose portion 254 so as to cover a tip part thereof. The pushrod 104 is movable with respect to the nose portion 254 in a predetermined range in the same direction as and in an opposite direction to the shooting direction, and is a kind of safety device used in performing a driving operation. The driving machine 201 is controlled so that, during driving of the nail 11, if the operator does not press the pushrod 104 against an object (driven material) into which the nail 11 is driven, the electric motor 13 does not rotate even if a trigger (trigger lever) 72 is pulled. When a tip side of the pushrod 104 in the shooting direction does not contact anything, the pushrod 104 is energized by a compression spring 105 and is located on the shooting direction side. When the operator presses the pushrod 104 against the object, the pushrod 104 moves in a direction opposite the shooting direction against a force of the compression spring 105 and then stops. When the pushrod 104 moves backward, a pressing detection switch (not illustrated) is switched on, and an output thereof is transmitted to a later-described controller. The controller allows activation of the electric motor 13 only when both states where the pushrod 104 is pressed and where the trigger 72 is pulled are realized.

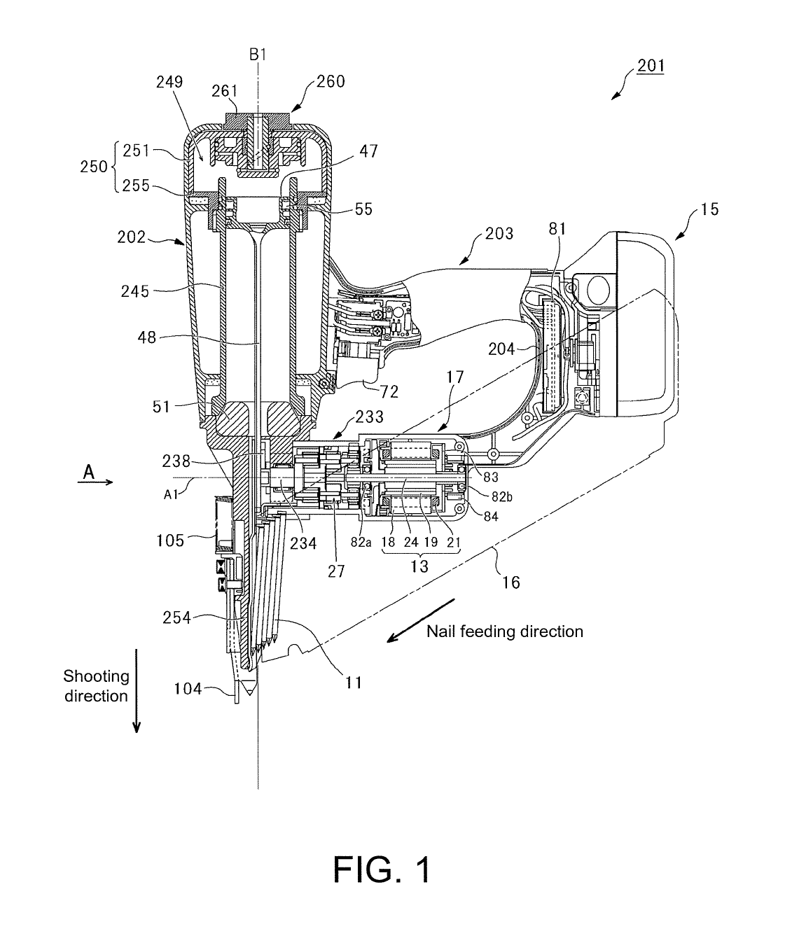

FIG. 2 is an arrow view as viewed from the direction A in FIG. 1, showing a state where the piston 47 is at the bottom dead point. In the present example, a moving mechanism is provided moving the piston 47 in a cylinder 45 in a direction in which pressure of the pneumatic chamber 249 is increased. This moving mechanism mainly includes the rotating body 238 rotated by a driving force of the electric motor 13, and the blade 48 having a rack 53. Herein, by rotating the rotating body 238 that has a pinion (gear) 241 on a part of its outer peripheral edge and meshing the pinion 241 with the rack 53 formed on a longitudinal side surface of the blade 48, the piston 47 is moved from the bottom dead point to the top dead point. The rotating body 238 and the pinion 241 are formed of an integral product made of metal, and the rotating body 238 is rotatable in a direction of arrow 242 or an opposite direction thereto by rotation of the drive shaft 234. The pinion 241 is arranged on the outer edge part of the rotating body 238 corresponding to a rotational angle of about 270 degrees. Thus, when the rotating body 238 rotates, a tip tooth 241a of the pinion 241 starts meshing with an upper end tooth 53a of the rack 53, and the blade 48 can thereby be moved upward. Accordingly, the piston 47 fixed to the blade 48 can also be moved toward the top dead point side.

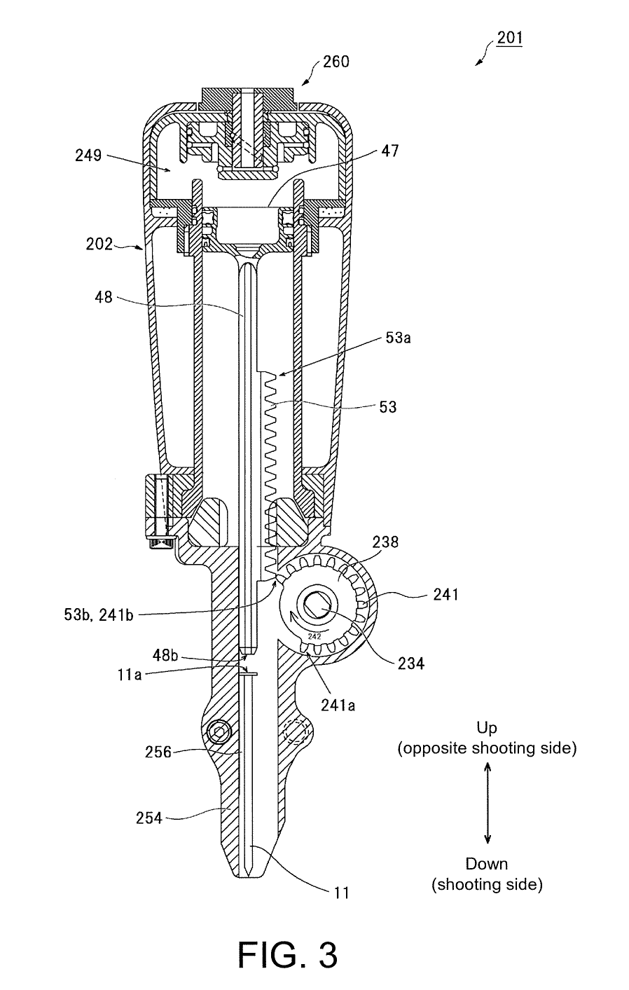

FIG. 3 shows a state where the rotating body 238 is rotated about 300 degrees in the direction of arrow 242 from the state in FIG. 2, showing a state immediately before the meshing between the rack 53 and the whole pinion 241 ends and meshing between a lower end tooth 53b of the rack 53 and a rear end tooth 241b of the pinion 241 is just about to be released. When a tip 48b of the blade 48 moves upward in a shooting path 256, the next nail 11 to be driven is fed from the magazine 16 into the shooting path 256. Immediately after the state in FIG. 3, i.e., when the piston 47 reaches the top dead point, since the contact state between the rear end tooth 241b of the pinion 241 and the lower end tooth 53b of the rack 53 is released, a force that supports the piston 47 that has compressed the air in the pneumatic chamber 249 is gone, and the piston 47 rapidly starts moving toward the bottom dead point due to a repulsive force of the compressed air in the pneumatic chamber. At this time point, the nail 11 has been loaded by the magazine 16 so that a head portion 11a comes to directly under the tip 48b of the blade 48. Thus, the blade 48 is capable of driving the nail 11 into an object.

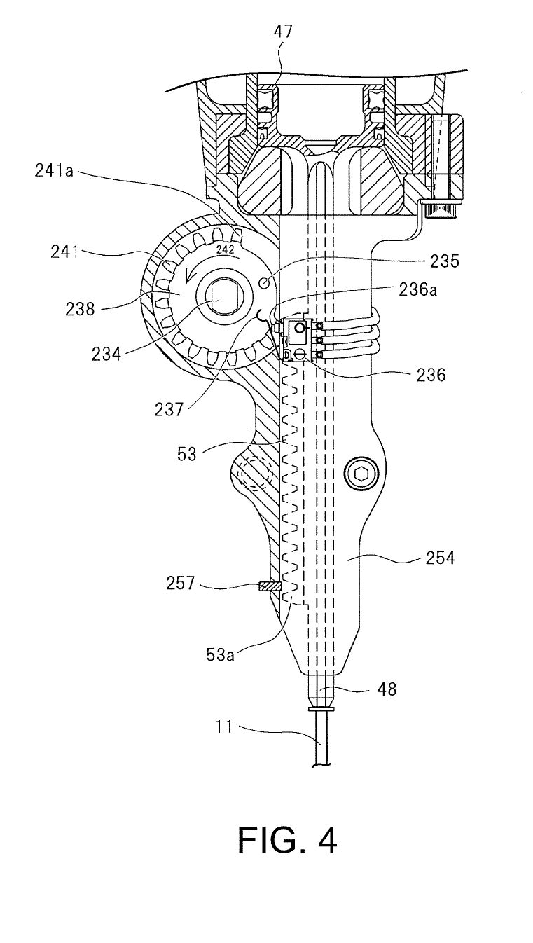

FIG. 4 shows a state after FIG. 3, and is an arrow view of the nose portion 254 after driving of the nail 11 is completed, as viewed from the side opposite the direction A in FIG. 1. During striking of the nail 11, since the electric motor 13 rotates, the drive shaft 234 also continues to rotate. However, in one place in a circumferential direction of the rotating body 238, a columnar pin 235 is provided parallel to the drive shaft 234, and the pin 235 acts on an off switch 236 at a timing at which the driving of the nail 11 ends. The off switch 236 is provided on a side surface of the nose portion 254, an output thereof is connected to a controller and an output pulse is transmitted at a timing at which the nail 11 is shot. An operating lever 237 for operating a plunger 236a is provided in the vicinity of the off switch 236. By rotation of the rotating body 238, the position of the pin 235 also moves in the circumferential direction. The operating lever 237 is made of a metal thin plate having elasticity, such as a spring material, and has on its tip a part bent into a semi-cylindrical shape. When the rotating body 238 rotates in the direction of arrow 242, the pin 235 provided parallel to the drive shaft 234 abuts against the semi-cylindrical portion of the operating lever 237, and the operating lever 237 is deformed by being pressed by the pin 235. Thus, the plunger 236a of the off switch 236 is pressed. Since the time point of pressing the plunger 236a is after completion of the driving of the nail 11, when the later-described controller receives an output signal of the off switch 236, the controller stops supplying driving power to the electric motor 13. After the plunger 236a is pressed, since the state where the operating lever 237 abuts against the pin 235 is released, the drive shaft 234 also stops and the rotating body 238 stops in the position in FIG. 4. Moreover, at the time point when the nail 11 is driven, the rack 53 and the pinion 241 are in a non-contact state.

Whether the nail 11 is correctly struck and whether the blade 48 has stopped in a correct position can be detected using a magnetic sensor 257. The magnetic sensor 257 is attached to the nose portion 254, and is provided in a position between the lower end tooth 53b of the rack 53 and an adjacent tooth when the piston 47 has moved to the bottom dead point. Due to approaching of the teeth of the rack 53 that protrude toward the magnetic sensor 257, the magnetic sensor 257 transmits a signal to the controller. Moreover, although the magnetic sensor 257 is large in FIG. 4 since it is schematically illustrated, in fact, the magnetic sensor 257 is miniaturized so as to be built in the nose portion 254, and a lead wire is also wired in an unnoticeable manner (thus, they are not illustrated in FIG. 1 to FIG. 3). When the piston 47 moves to the bottom dead point, since only the lower end tooth 53b of the blade 48 crosses in front of the magnetic sensor 257, an output signal corresponding to one pulse is transmitted from the magnetic sensor 257 to the controller. Thus, the controller is capable of correctly identifying whether the blade 48 has moved to a shooting position according to presence or absence of this output signal. Since in this stopped state, the piston 47 is located at the bottom dead point, after the operator releases the pushrod 104 temporarily, by again pressing the pushrod 104 in a next striking position to pull the trigger 72, the next striking operation can be started. When nail clogging occurs, the lower end tooth 53b of the blade 48 does not pass in front of the magnetic sensor 257. Accordingly, when nail clogging is detected, pressure in a pressure accumulation chamber is released, and the operator performs an operation of removing the clogging nail after the release step.

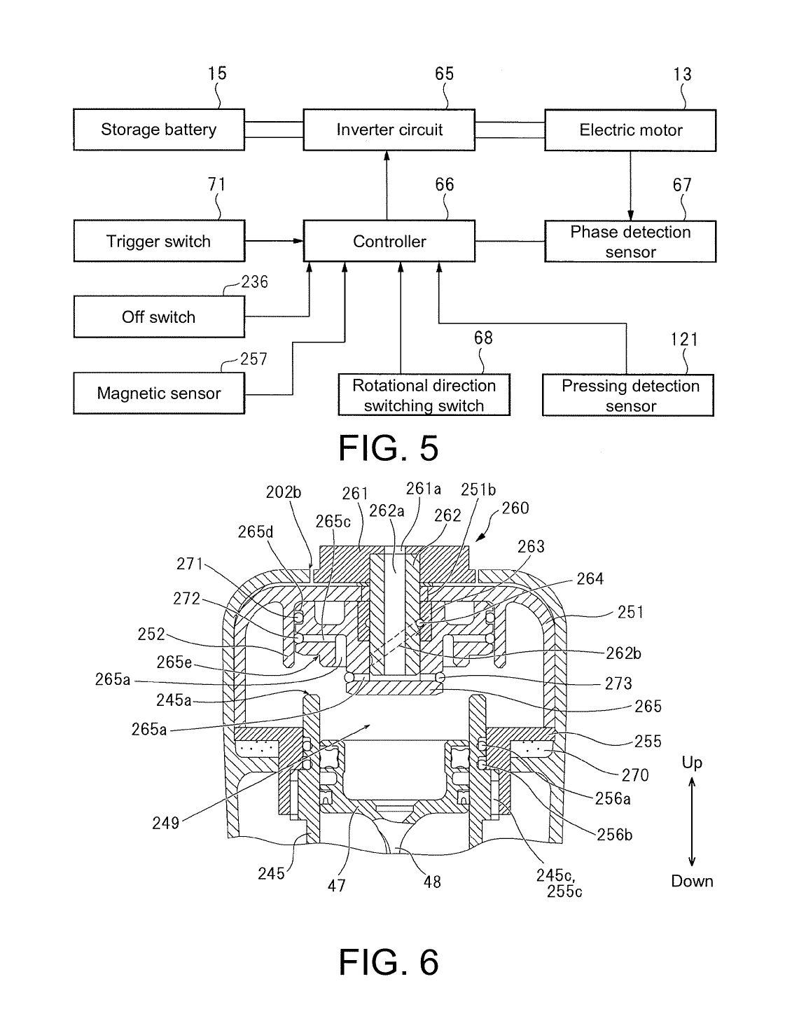

FIG. 5 is a control block diagram of the driving machine 210 of the present example. An inverter circuit 65 is a circuit generating, from a DC current from the storage battery 15, a three-phase AC current (excitation current) for driving the electric motor 13, and is mounted on the inverter circuit substrate 83 (see FIG. 1) provided on a rear end side of the electric motor 13. The inverter circuit 65 includes six switching elements 84 (see FIG. 1) connected to the coil of the stator 18 of the electric motor 13, and on/off of the switching elements 84 is controlled by a controller 66. The controller 66 controls rotation of the electric motor 13 during striking (second step) of the nail 11 and controls rotation during pressurization (first step) of the pneumatic chamber 249 using the electric motor 13. The controller 66 is configured by including a microcomputer (hereinafter referred to as “micon”) (not illustrated). A phase detection sensor 67 detecting a phase of the rotor 19 in a rotational direction is provided in the electric motor 13. The phase detection sensor 67 can be realized by including a plurality of Hall ICs that detect a magnetic field of the permanent magnet contained in the rotor 19 of the electric motor 13. The controller 66 is capable of obtaining a position of the rotor 19 in the rotational direction and a rotational speed of the rotor 19 based on a signal of the phase detection sensor 67. The controller 66 estimates a position of the rotating body 38 in the rotational direction, i.e., a rotational angle of the rotating body 38, based on the signal of the phase detection sensor 67 and a gear ratio of the decelerator 27.

A rotational direction switching switch 68 is provided switching the rotational direction of the rotor 19 of the electric motor 13. The rotational direction switching switch 68 is operated by the operator. The rotational direction switching switch 68 has operation positions for normal rotation and reverse rotation. Furthermore, the signal of the off switch 236 that detects completion of the driving of the nail 11 and the signal of the magnetic sensor 257 that detects whether or not the blade 48 has reached the bottom dead point are inputted to the controller 66. The controller 66 processes the signal inputted from the phase detection sensor 67 so as to estimate the position of the piston 47 in the direction of the center line B1 of a cylinder 46. A trigger switch 71 (see FIG. 1) is a switch mechanism switched on and off by the operator operating the trigger 72 (see FIG. 1). A signal of the trigger switch 71 is inputted to the controller 66. Furthermore, a pressing detection sensor 121 is provided detecting whether or not the pushrod 104 is being pressed against the object, and a signal outputted from the pressing detection sensor 121 is inputted to the controller 66. Based on the signals of these switches and sensors, the controller 66 controls the rotation, stopping, rotational speed and rotational direction of the electric motor 13.

Next, operation and control of the driving machine 10 are explained. When the trigger switch 71 is switched on, the controller 66 controls the inverter circuit 65 to supply a current to the coil 21, and rotates the rotor 19 of the electric motor 13. Based on a signal of the rotational direction switching switch 68, the controller 66 controls a direction of the current flowing to the coil 21 and determines the rotational direction of the rotor 19. In addition, based on the signal of the phase detection sensor 67, the controller 66 detects the position of the rotor 19 in the rotational direction, and controls a timing of switching on and off the switching element of the inverter circuit 65 and an ON ratio, i.e., duty ratio, of the switching element. In this way, the rotational speed of the rotor 19 per unit time is controlled. The electric motor 13 is capable of switching the rotational direction of the rotor 19 between normal rotation and reverse rotation by switching the direction in which the current is supplied to the coil 21. When the rotor 19 rotates, a rotational force of the output shaft 24 is transmitted to the drive shaft 234 via the decelerator 27.

When striking is performed using the driving machine 10, the first step of increasing the air pressure in the pneumatic chamber 249 is performed in advance if necessary. The first step is a preparation step before start of the striking operation, and may be performed only when the pressure of the pneumatic chamber 249 is reduced (e.g., every several weeks to every several months). Normally, the process can be suddenly executed from the second step (normal driving operation). In the second step, when the operator presses the pushrod 104 against the object and pulls the trigger 72, the air pressure in the pneumatic chamber 249 further increases and the nail 11 is struck.

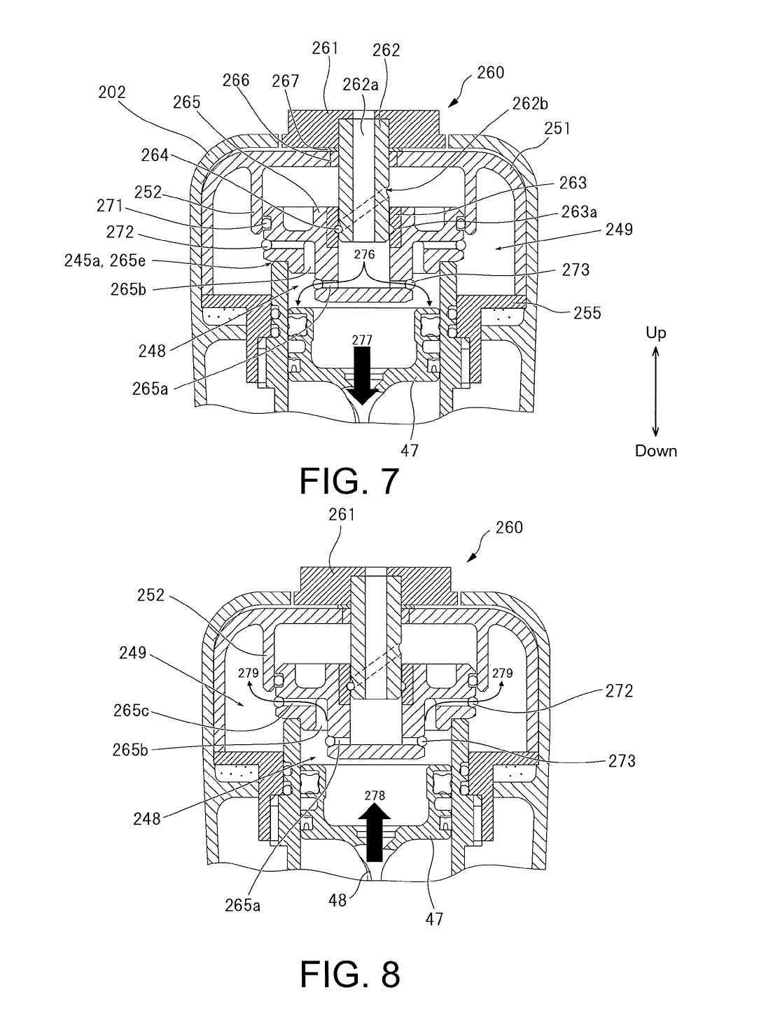

Next, a procedure for increasing the pressure of the pneumatic chamber 249 in the first step is explained using FIG. 6 to FIG. 8. FIG. 6 to FIG. 8 are partial enlarged views of the vicinity of the external air intake valve 260 provided in the pressure accumulation container 250 in FIG. 1. FIG. 6 shows a state where the external air intake valve 260 is closed, showing a state where intake of the external air to the pressure accumulation container 250 is inhibited. The external air intake valve 260 is an on-off valve mechanism provided to pass through a through hole 251b provided on an upper side of the pressure accumulation container 250, wherein inflow of air from the external air toward the pneumatic chamber 249 is allowed in an opened state (FIG. 7 and FIG. 8), and flow of air between the external air and the inside of the pneumatic chamber 249 is completely blocked in a closed state (FIG. 6). The pressure accumulation container 250 is accommodated within the main body housing 202 made of synthetic resin, and a cushion material 270 is provided on a lower side of the flange portion 255 so that the pressure accumulation container 250 is held without wobbling. The cylinder 245 and the cylindrical part of the flange portion 255 are screwed by a male thread 245c formed on a side of the cylinder 245 and a female thread 255c formed on an inner peripheral side of the flange portion 255. Furthermore, two O-rings 256a and 256b are interposed on an upper side of the screw part to improve confidentiality.

The external air intake valve 260 is configured by including: a selector 265 being a main component of the valve mechanism; a cylindrical sleeve 262 for holding the selector 265 and moving the selector 265 in the axial direction (direction of the axis line B1), a movable mechanism (264, and 262a and 263b shown in FIG. 7) converting a rotational force of the cylindrical sleeve 262 into a moving force of the selector 265 in the axial direction; and a switching lever 261 for rotating the cylindrical sleeve 262. The switching lever 261 is a knob arranged inside a through hole 202b formed in an upper portion of the main body housing 202, and fixes the hollow cylindrical sleeve 262 having an external air intake passage 262a formed in the center. A through hole 261a is also formed in the center of an upper portion of the switching lever 261 and communicates with the external air intake passage 262a. A ring-shaped metal 266 is attached to a through hole formed in the container main body portion 251, and the cylindrical sleeve 262 is held movable in the B1 axial direction by the metal 266. A washer 267 is interposed between the switching lever 261 and the cylindrical sleeve 262. The selector 265 is provided on a lower side of the cylindrical sleeve 262. The selector 265 is configured to be movable in the axial direction while rotating, and has a cup-shaped inner wall surface abutting against an outer peripheral side of the cylindrical sleeve 262. A communicating path 265a for communicating the cup-shaped inner part with an outer part of the selector 265 is formed in the vicinity of a bottom (lower side surface) of the cup-shaped inner wall surface. The communicating path 265a is two or a plurality of through holes extending radially outward from an axial center of the selector 265, wherein when a lower end portion of the cylindrical sleeve 262 is separated from a bottom surface portion of the selector 265, the external air intake passage 262a and the pneumatic chamber 249 can communicate with each other by the communicating path 265a. In an outer peripheral outlet of the communicating path 265a, a groove portion is formed so as to be continuous in a circumferential direction, and an O-ring 273 made of rubber is arranged in the groove portion. The O-ring 273 functions as a check valve to block flow of air from the side of the pneumatic chamber 249 toward the communicating path 265a, and, in contrast, to allow flow of the air from the side of the communicating path 265a toward the pneumatic chamber 249 when there is an air pressure difference. In the cylinder 245, a cylindrical depression 265b having a cylindrical shape from bottom to top and two or a plurality of communicating paths 265c extending radially outward from the cylindrical depression 265b are further formed. In an outer peripheral outlet of the communicating path 265c, a groove portion is formed so as to be continuous in the circumferential direction, and an O-ring 272 made of rubber and functioning as a check valve is arranged in the groove portion.

The movable mechanism that converts the rotational force of the cylindrical sleeve 262 into the moving force of the selector 265 in the axial direction includes a collar 263 and a steel ball 264 provided on an inner peripheral side of the selector 265. A hemispherical depression 263a (see FIG. 7) is formed on an inner peripheral surface of the collar 263. A spline groove 262b formed over a rotational angle of 180 degrees while varying in the circumferential direction and axial direction is formed on an outer peripheral surface of the cylindrical sleeve 262. The steel ball 264 is arranged between the spline groove 262b and the depression 263a. When the operator rotates the switching lever 261 about 180 degrees in the circumferential direction, with this rotation, the cylindrical sleeve 262 also rotates. Thereupon, the steel ball 264 is guided by the obliquely arranged spline groove 262b, and the collar 263 thereby moves axially downward. The state after movement is as shown by the state of the selector 265 in FIG. 7.

In FIG. 7, the selector 265 is moved downward by the movable mechanism. By a close contact between a stepped portion 265e formed on a lower side of the selector 265 and an opening portion 245a on an upper end of the cylinder 245, space of the pneumatic chamber 249 is separated from space of the cylinder chamber 248. On this occasion, since an O-ring 271 arranged in an upper outer peripheral groove 265d (see FIG. 6) of the selector 265 abuts against an inner wall part of a cylindrical portion 252 formed on an inner peripheral side of the container main body portion 251, the pneumatic chamber 249 is maintained in a state sealed from the external air or the cylinder chamber 248. By the O-ring 272, only flow of the air from the cylinder chamber 248 toward the pneumatic chamber 249 is allowed (only when there is a pressure difference).

As shown in FIG. 7, when the switching lever 261 is operated and the external air intake valve 260 is in the “opened” state, if the piston 47 is moved in a direction of arrow 277, since the pressure in the cylinder chamber 248 becomes negative, the external air is introduced into the cylinder chamber 248 through the external air intake passage 262a and the communicating path 265a, as shown by arrow 276. On this occasion, since the O-ring 273 is deformed so as to extend to an outer peripheral side, flow of the air shown by arrow 276 is allowed. By moving the piston 47 from the state (state where the piston 47 is located slightly lower than the top dead point) in FIG. 6 to the bottom dead point in this way, the external air can be introduced into the cylinder chamber 248. When the piston 47 reaches the bottom dead point, the piston 47 is again moved to the vicinity of the top dead point (but the piston 47 does not reach the top dead point). This state is shown in FIG. 8.

In FIG. 8, when the piston 47 is moved in the direction of arrow 278, since the pressure in the cylinder chamber 248 becomes sufficiently greater than the pressure in the pneumatic chamber 249, the air flows from the cylindrical depression 265b toward the pneumatic chamber 249 through the communicating path 265c as shown by arrow 279. Moreover, since the O-ring 273 is pressed by the air pressure from outside to inside and therefore closes the communicating path 265a, the air in the cylinder chamber 248 is not released outside. On the other hand, the O-ring 272 moves radially outward due to the high pressure on the side of the communicating path 265c, thereby allowing flow of the air in the direction of arrow 279. As a result, an amount of air in the pneumatic chamber 249 can be increased to increase the air pressure.

In this way, the operation of increasing the air pressure of the pneumatic chamber 249 in the first step is executed by moving the piston 47 in the cylinder chamber 248. A power source of the piston 47 may be anything as long as it is capable of moving the piston 47 or the blade 48. Theoretically, the blade 48 can be moved in an up-down direction by hand or by using a specialized movable tool. However, in the present example, a driving source for moving the blade 48 during the striking operation is used. Herein, the pressurization in the pneumatic chamber 249 and the cylinder chamber 248 in the first step is performed using the electric motor 13. Hence, in the present example, as the electric motor 13, a brushless DC motor capable of detecting a rotation position with good accuracy by a micon and capable of performing control of normal rotation and reverse rotation with high accuracy is used. That is, in the first step, by reversely rotating the electric motor 13, the piston 47 that has reached a position immediately before the top dead point is lowered to the bottom dead point; when the piston 47 reaches the bottom dead point, by again normally rotating the electric motor 13, the piston 47 is moved to the position immediately before the top dead point. The reverse rotation and normal rotation of the electric motor 13 are performed within a range in which meshing between the rack 53 and the pinion 241 is not released, and are controlled with high accuracy by the micon contained in the controller 66. By repeating the pressurization operation (one stroke) by the piston 47 in the piston chamber 248 a plurality of times in this way, the air pressure of the pneumatic chamber 249 can be increased to about 3 to 5 atmospheres. When the pneumatic chamber 249 is pressurized to a predetermined air pressure, since execution of the pressure accumulating mode is terminated by the micon, the operator returns the switching lever 261 of the external air intake valve 260 to the original position shown in FIG. 6. In this state, advance preparation (pressure accumulating mode) for driving of the nail 11 is completed.

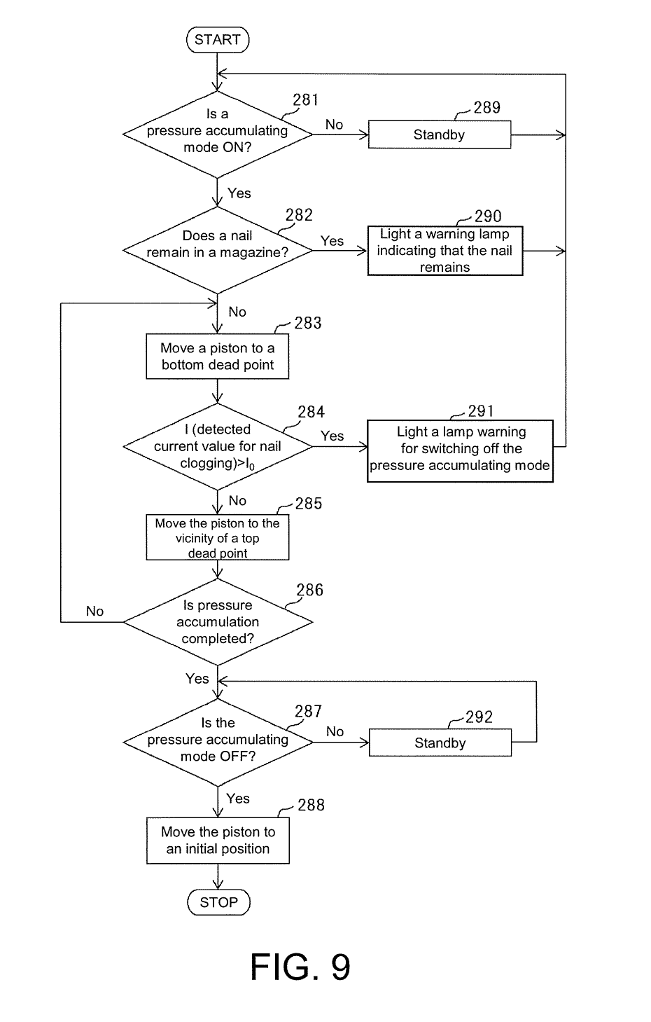

Next, a procedure for pressurizing the pneumatic chamber 249 in the first step using the electric motor 13 is explained using the flowchart in FIG. 9. The sequential procedure shown in FIG. 9 can be executed by software by the micon contained in the controller 66 using a pre-stored program. The flowchart in FIG. 9 is started from, as a state where the switching lever 261 is rotated from the state shown in FIG. 6, and the selector 265 is lowered and the stepped portion 265e abuts against the opening portion 245a of the cylinder 245 as shown in FIG. 7, a state where a switch (switching lever 261) of the pressure accumulating mode is switched on (“ON”) (step 281). Moreover, although not illustrated in FIG. 6 to FIG. 8, a sensor may be provided detecting the position of the switching lever 261, so that it can be detected by the controller 66 that the switching lever 261 is switched.

First of all, the micon detects whether the pressure accumulating mode has become ON after the switching lever 261 is rotated (step 281). If the pressure accumulating mode is not achieved, standby is performed until the operator switches to the pressure accumulating mode (step 289). When the pressure accumulating mode is achieved, the micon detects whether or not the nail 11 remains in the magazine 16 and a nail shooting path (step 282). For this detection, a well-known stopper sensor or the like that detects whether the nail 11 is mounted in the shooting path 256 and presence or absence of the nail 11 may be provided. If the nail 11 remains in the magazine 16 or the shooting path, a warning lamp indicating that the nail 11 remains blinks, and standby is performed until the operator removes the nail 11 (step 290). Herein, when the nail 11 in the magazine 16 and the shooting path 256 is gone, rotation of the electric motor 13 becomes possible. When the trigger 72 is pulled by the operator, the micon reversely rotates the electric motor 13 and reversely rotates a hoisting cam (rotating body 238), thereby moving the piston 47 to the bottom dead point side (step 283). Thereby, the external air is attracted into the piston chamber 248 as shown by arrow 276 in FIG. 7. Moreover, during the initial reverse rotation of the cam in the pressure accumulating mode, since the piston 47 is almost located at the bottom dead point, step 283 terminates in an instant.

Next, by detecting a current value I flowing to the motor during reverse rotation of the cam (rotating body 238), the micon detects whether the nail 11 is clogging in the shooting path, i.e., whether a nail clogging state is present. The determination can be performed according to whether or not the detected current value I exceeds a threshold I₀ of current indicating nail clogging (step 284). The micon monitors the current value I at all times through a current detection circuit contained in a control circuit for driving the electric motor 13. Thus, by using a detected value thereof, there is no need to provide a new current detection means. Herein, the reason is that, when the piston 47 is lowered, if the piston 47 can be smoothly lowered by the electric motor 13, the current value I flowing to the motor does not become very large. If the current value I exceeds the set current value (threshold I₀), movement of the piston 47 and the blade 48 is thereby hindered. Therefore, the warning lamp indicating that the nail 11 remains blinks, and standby is performed until the operator removes the nail 11 (step 291).

Next, the micon normally rotates the electric motor 13 (rotation in a direction of hoisting the piston 47 during striking and rotation in a direction shown by the arrow in FIG. 2) to normally rotate the hoisting cam (rotating body 238), thereby moving the piston 47 from the bottom dead point to the vicinity of (before) the top dead point (step 285). By this movement, the air (air attracted from the outside) in the cylinder chamber 248 can be sent into the pneumatic chamber 249 as shown by arrow 249 in FIG. 8. Herein, when the piston 47 is moved to the top dead point, since an engaged state between the hoisting cam (rotating body 238) and the rack 53 of the blade 48 is released, and the piston 47 rapidly moves due to pressure of the accumulated air (similarly as in the striking mode), it is important to stop the rise of the piston 47 at the position immediately before the top dead point. By the lowering operation (step 283) and the rising operation (step 285) of the piston 47 in this way, as shown in FIG. 7 and FIG. 8, the external air is attracted through the external air intake valve 260 to increase the amount of the air in the pneumatic chamber 249, and the air pressure can be increased.

Next, the micon determines whether or not the pressure accumulation performed by the lowering and rising operations of the piston 47 is completed (step 286). Whether the pressure accumulation (pressurization operation) is completed can be carried out by, for example, any of the following methods. (1) The current value I flowing to the electric motor 13 when the piston 47 is moved from the bottom dead point side to the top dead point side is detected, so as to determine whether the current value I has become greater than a threshold I₁ at the time of completion of the pressure accumulation operation. The reason is that, when the pressure (assumed to be increased to about 3 to 5 atmospheres by the pressure accumulating mode) in the pneumatic chamber 249 increases, since a load during movement of the piston 47 from the bottom dead point side to the top dead point side increases, the current value I increases with the increase in the load. (2) A pressure sensor (not illustrated) measuring the pressure in the pneumatic chamber 249 is provided, and whether or not the pressure P exceeds a set pressure P₀ is detected. This method directly measures the air pressure and is therefore the most accurate method. However, since it is necessary to provide the pressure sensor, the cost will increase and devices will increase in size. (3) The micon counts how many times the one-stroke operation has been executed, wherein the one-stroke operation refers to that the piston 47 is returned from the position immediately before the top dead point to the bottom dead point and is again raised from the bottom dead point to the position immediately before the top dead point. When the number of times of this reciprocating movement of the piston is executed N times, wherein N is a threshold being a predetermined number of times, the pressure accumulation operation is terminated. The threshold can be set to, for example, three times. When it is determined that the pressure accumulation operation is completed by any of the above methods (step 286), the micon detects whether the pressure accumulating mode has become OFF after the switching lever 261 is rotated (step 287). If the pressure accumulating mode is maintained, standby is performed until the operator operates the switching lever 261 to switch off the pressure accumulating mode (step 292). When the pressure accumulating mode becomes OFF, i.e., when the switching lever 261 is returned to the state in FIG. 6, the micon returns the piston 47 to an initial position (the bottom dead point or a predetermined position near the bottom dead point) (step 288), and the pressure accumulation process of the pneumatic chamber 249 by the first step is terminated. After that, the operator can execute the actual nail driving operation (second step).

As described above, according to the first example, since pressure of a gas in the pneumatic chamber 249 can be increased by movement of the piston 47 driven by the electric motor 13, a driving machine having long life and high performance can be realized without being bothered by pressure reduction in the pneumatic chamber due to longtime use.

### Example 2

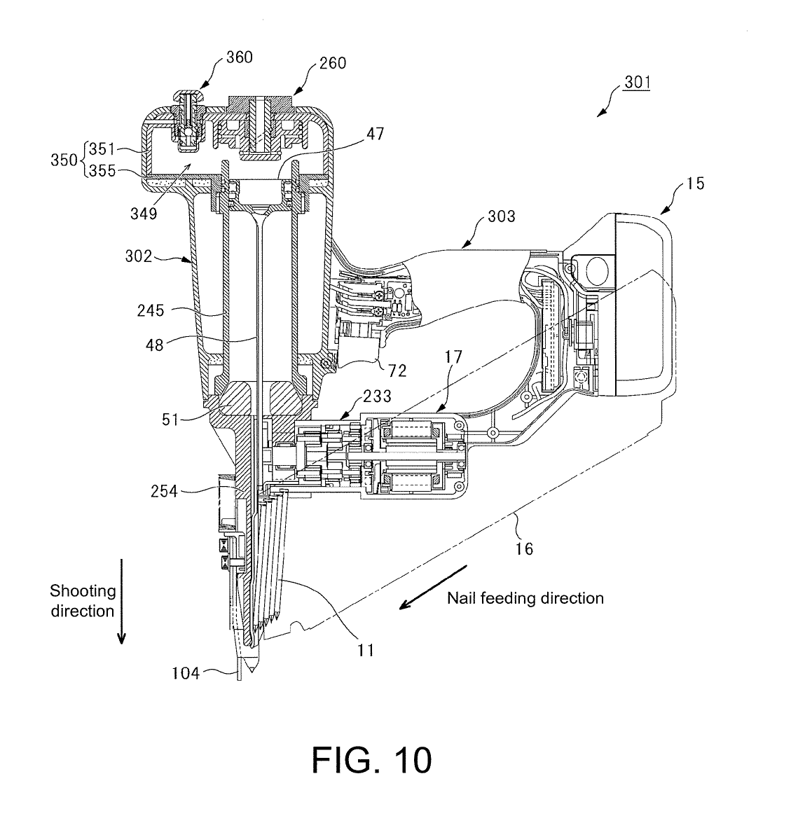

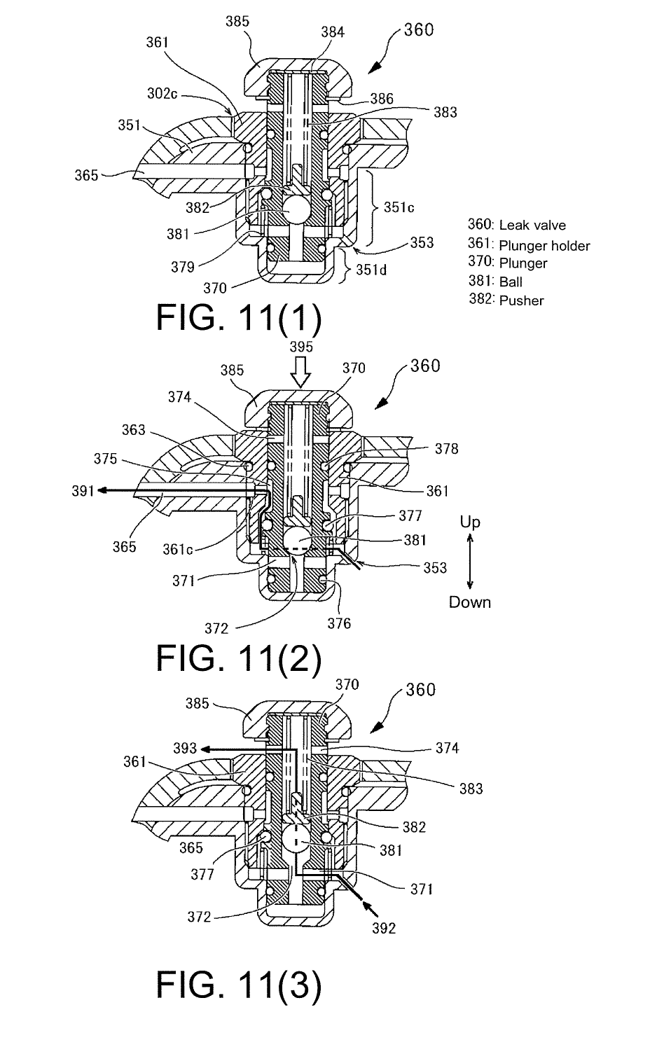

Next, the second example of the present invention is explained using FIG. 10 and FIG. 11. In a driving machine 301 of the second example, a difference from the first example is that a manual leak mechanism, i.e., the leak valve 360, for allowing internal air to escape to the outside when pressure of a pneumatic chamber 349 exceeds a predetermined value, is provided in a pressure accumulation container 350. Hence, the shape of the pressure accumulation container 350 is extended in the radial direction, and the leak valve 360 is provided in a position adjacent to the external air intake valve 260 on an upper surface of the pressure accumulation container 350. The structure or function of the external air intake valve 260 is the same as that explained in the first example. Similarly to the first example, the pressure accumulation container 350 is made in a two-piece form using a container main body portion 351 and a flange portion 355. However, as a container storing compressed air, it may be of an integral type or of a divided type, or may have other structures. The shape of an upper part of a main body housing 302 of the driving machine 301 changes with the change in the shape of the pressure accumulation container 350. However, except the shape of the part in the vicinity of the pressure accumulation container 350, the other parts have the same structures as those in the driving machine 201 of the first example.

FIG. 11 is longitudinal sectional views showing a detailed structure of the leak valve 360. In the leak valve 360, in addition to the function as a “release valve” which allows the internal air to escape to the outside when the pressure of the pneumatic chamber 349 (see FIG. 10) exceeds the predetermined value, a function as a “leak valve” which enables the operator to discharge the air in the pneumatic chamber 349 at arbitrary timing is provided. When the nail 11 clogs in the shooting path 256 (see FIG. 2) formed in the nose portion 254, the arbitrary exhaust function by the leak valve is convenient to use when removing the clogging nail 11. The reason is that, while the pressure of the pneumatic chamber 349 remains high, even if trying to remove the nail 11, it is sometimes difficult to move the blade 48. On the other hand, if the air in the pneumatic chamber 349 is released during removal of the nail 11, since atmospheric pressure is reached in the pneumatic chamber 349 and the cylinder chamber 248, the operator can easily move the blade 48. Furthermore, if the pneumatic chamber 349 is returned to atmospheric pressure, there is no longer force to move the piston 47. Thus, there is no longer a fear that the striking operation may be performed by mistake, and safety is thus further improved.

In FIGS. 11(1) and (2), a through hole 353 being an outlet of the air in the pneumatic chamber 349 is formed in the container main body portion 351 of the pressure accumulation container 350, and the leak valve 360 is provided allowing discharge of the air from the through hole 353 in a predetermined state. The leak valve 360 is configured by including: a large-diameter portion 351c and a small-diameter portion 351d in which the container main body portion 351 protrudes inward in a cup shape; a cylindrical plunger 370 movable in the large-diameter portion 351c and the small-diameter portion 351d in the axial direction; a plunger holder 361 for holding the plunger 370 on the container main body portion 351; a push button 385 for moving the plunger 370; a ball 381 arranged inside the cylindrical plunger 370; and a pusher 382 for energizing the ball 381 in a predetermined direction.

A plurality of passages (communicating paths 371 and 374), and a narrowed part 372 for realizing a valve mechanism by the ball 381 are formed in the plunger 370. O-rings 376 to 378 made of rubber and for maintaining airtightness between the plunger 370 and the plunger holder 361 are provided on an outer peripheral surface of the plunger 370. The ball 381 is inserted from outside the container main body portion 351 into the plunger 370, energized by the pusher 382 and a coil spring 383, and held by a metal plate 384. The metal plate 384 is retained by the push button 385 made of synthetic resin. Moreover, a retaining ring 386 is inserted into a lower side of the push button 385. The plunger holder 361 holds the plunger 370 on the container main body portion 351, and forms or closes a predetermined air passage along with a groove portion on an outer peripheral side of the plunger 370. The plunger holder 361 passes through a through hole 302c of the main body housing 302, and is pressed into the large-diameter portion 351c of the container main body portion 351. An O-ring 363 is provided in order to maintain airtightness between the plunger holder 361 and the large-diameter portion 351c. In addition, a discharge pipeline 365 extending the container main body portion 351 in a direction orthogonal to the axial direction. The discharge pipeline 365 is formed by drilling or the like into a part of the container main body portion 351, and communicates outside the main body with a horizontal hole 361c formed in the plunger holder 361.

FIG. 11(1) shows a state where the driving machine 301 is not in use or where a normal striking operation is being performed. (2) shows a state where the push button 385 is pressed down in a direction of arrow 395 by the operator, wherein by moving the push button 385 axially downward, an air passage from the through hole 353 to the discharge pipeline 365 is delimited as shown by arrow 391. Herein, the air passes through a gap between a lower end portion of the plunger holder 361 and an inside of the large-diameter portion 351c from the through hole 353, passes through a gap formed between an inclined surface portion on an inner peripheral side of the plunger holder 361 and an O-ring 377 to flow upward, and flows to the part of a wide groove 375 continuous in the circumferential direction so as to continue from the axial lower side. The air is discharged outside from the discharge pipeline 365, as shown by arrow 391. During discharge of the air, a discharge sound of high pressure air occurs. However, when this sound stops and the operator releases the press-down of the push button 385, the plunger 370 returns to the state in (1) due to a restoring force of a coil spring 379. In this way, in cases where nail clogging occurs, decompression of the pressure accumulation container 350 performed by pressing down the push button 385 can be operated when removing the clogging nail.

FIG. 11(3) shows a condition when the leak valve 360 acts as a release valve when pressurization of the pneumatic chamber 349 of the driving machine 301 is performed and a specified amount or more of air is taken in. It is assumed that the driving machine 301 of the present example drives a nail having a length of about 50 to 90 mm. In a preparation step (first step) before pressure accumulation, the pressure in the pneumatic chamber is set to about 5 to 8 atmospheres; in the striking step (second step) of performing actual driving, the pressure in the pneumatic chamber is increased up to about 10 to 14 atmospheres. If the striking step is performed after the pressure accumulation in the first step is performed in a specified amount or more, the pressure of the pneumatic chamber 349 may exceed the predetermined value. On that occasion, excess air is discharged outside by a path of arrow 393 shown in (3). In the state of (3), since the push button 385 is in the same normal position as in (1), the discharge path shown in (2) cannot be taken. Accordingly, the communicating path 371 is provided spatially connecting the narrowed part 372 closed by the ball 381 to the gap between the lower end portion of the plunger holder 361 and the inside of the large-diameter portion 351c, and the pressure (arrow 392) of the pneumatic chamber 349 is applied to the ball 381. Thus, when a predetermined amount or more of air pressure is applied to the ball 381, the coil spring 383 is compressed through the pusher 382. Thereby, the ball 381 is separated from the narrowed part 372. Thereupon, the excess air flows around the ball 381 and is discharged outside through the communicating path 374, as shown by arrow 393. Moreover, although in (3), arrow 393 illustrates that the discharge is performed leftward, the discharge may also be performed rightward in the same way. On this occasion, when a predetermined amount of air is discharged and the pressure of the pneumatic chamber 349 becomes an appropriate air pressure, a spring force of the coil spring 383 becomes stronger than the pressure (arrow 392) of the pneumatic chamber 349, and the ball 381 is again pressed against the narrowed part 372. Thereby, the leak valve 360 returns to the state in FIG. 11(1), and the airtight state in the pneumatic chamber 349 is maintained.

As described above, according to the second example, when nail clogging occurs and removal of the nail is performed, since the operator can release the high pressure air in the pneumatic chamber 349, the removal of the nail can be performed in a safe state. In addition, in cases such as where the driving machine is not in use over a long period of time, since the high pressure air in the pneumatic chamber 349 can be released if the operator wishes, a seal part of the pneumatic chamber or a seal portion of the piston can be prevented from aged deterioration at an early stage. Furthermore, when a high pressure equal to or higher than a specified value is reached in the pneumatic chamber 349, since excess internal air can be automatically discharged, there is no fear of failure in the pressurization in the first step.

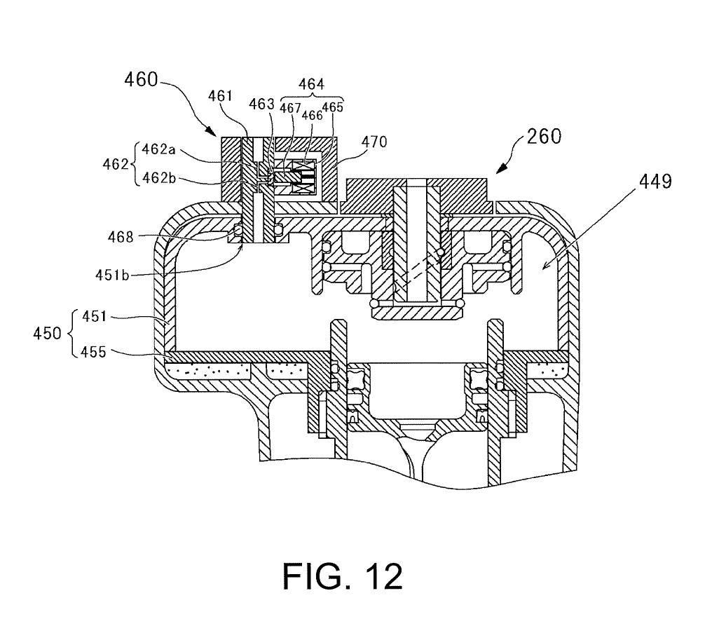

FIG. 12 shows a modification of the second example, obtained by replacing the leak valve 360 in FIG. 11 with an electromagnetic valve 460. The electromagnetic valve 460 is arranged so as to pass through a container main body portion 451, wherein a discharge pipe 461 forming a communicating path 462 of discharged air, a valve 463 for opening or closing the communicating path 462, and a solenoid actuator 464 moving the valve 463 are provided. The discharge pipe 461 is a substantially cylindrical member in which an axial center is closed. The discharge pipe 461 is mounted in a through hole portion 451b of the container main body portion 451, and is attached by interposing an O-ring 468 made of rubber therebetween. In the closed part of the discharge pipe 461, extremely thin communicating paths 462a and 462b are formed extending in the axial direction and radial direction. The parts of the communicating paths 462a and 462b extending in the radial direction are exposed in a depressed part formed on an outer peripheral side of the discharge pipe 461, and the valve 463 is arranged so as to cover the depressed part. The solenoid actuator 464 moves an iron core 467 by magnetic force inside a coil 466 provided within a housing 465. The iron core 467 is fixed to the valve 463. By energizing the coil 466, the valve 463 is moved so as to approach the side of the communicating path 462; by stopping energization to the coil 466, the valve 463 is moved to the side away from the communicating path 462 due to action of a spring (not illustrated). By separation of the valve 463 from the communicating path 462, a space is formed between the depressed part of the discharge pipe 461 and the valve 463, and the paths 462a and 462b communicate with each other. Therefore, air pressurized in a pneumatic chamber 449 can be discharged outside through the discharge pipe 461. By driving the solenoid actuator 464 by control of the micon in this way, it becomes possible to control opening or blocking of the communicating path 462.

As described above, according to the second example, when an abnormality such as nail clogging occurs and the micon detects that it is necessary to remove the nail, by the micon operating the electromagnetic valve 460, high pressure air in the pneumatic chamber 449 can be released. Thus, the operator can perform removal of the nail can be performed in a safe state. In addition, after the removal of the nail is completed, the operator operates the external air intake valve 260 and the pressure accumulating mode to increase the pressure of the pneumatic chamber 449 can be executed. Thus, a user-friendly driving machine can be realized.

### Example 3

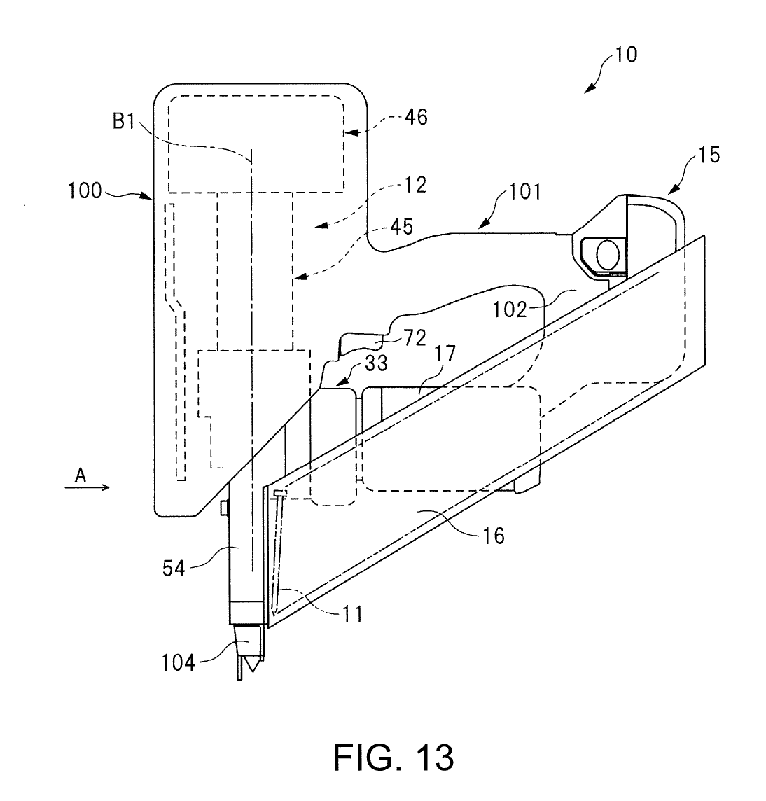

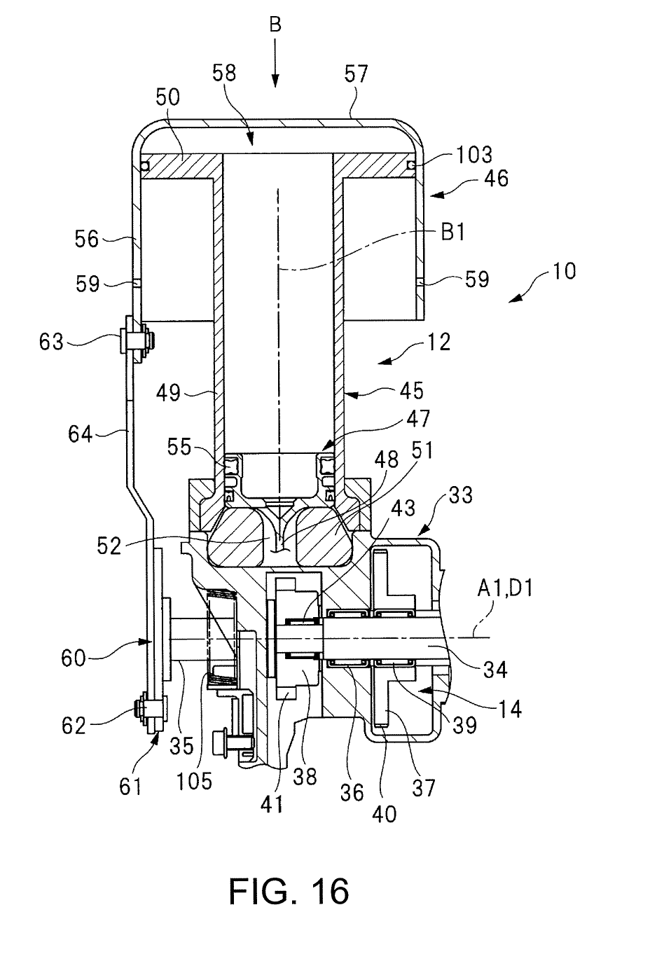

Next, the third example of the present invention is explained using FIG. 13 to FIG. 16. The basic configuration of FIG. 13 is almost the same as that of the driving machine 201 explained in the first example, particularly in terms of the nail feeding mechanism such as the magazine 16, driving performed by the electric motor 13, shape of a grip 101 or a mounting portion 1, that the storage battery 15 is used as a power source, and that the storage battery 15 is attachable to and detachable from a mounting portion 102. A main difference lies in a striking mechanism 12 that strikes the nail 11, and the mechanism for pressurizing a pneumatic chamber is different. Herein, unlike the first example in which pressure accumulation is performed using the piston 47, a pneumatic chamber is constituted by the movable second cylinder 46, and the cylinder 46 is movable in the up-down direction by the driving force of the electric motor 13 (described later). In addition, a shape of a cover 100 also varies according to the form of the cylinder 46. The electric motor 13 (not illustrated) is provided within the motor housing 17, and its structure is a brushless DC motor of the same type as that explained in FIG. 1. The decelerator 27 of the same type as that explained in FIG. 1 is accommodated in the casing 33 adjacent to the motor housing 17, and the casing 33 is connected to a cylindrical nose portion 54.

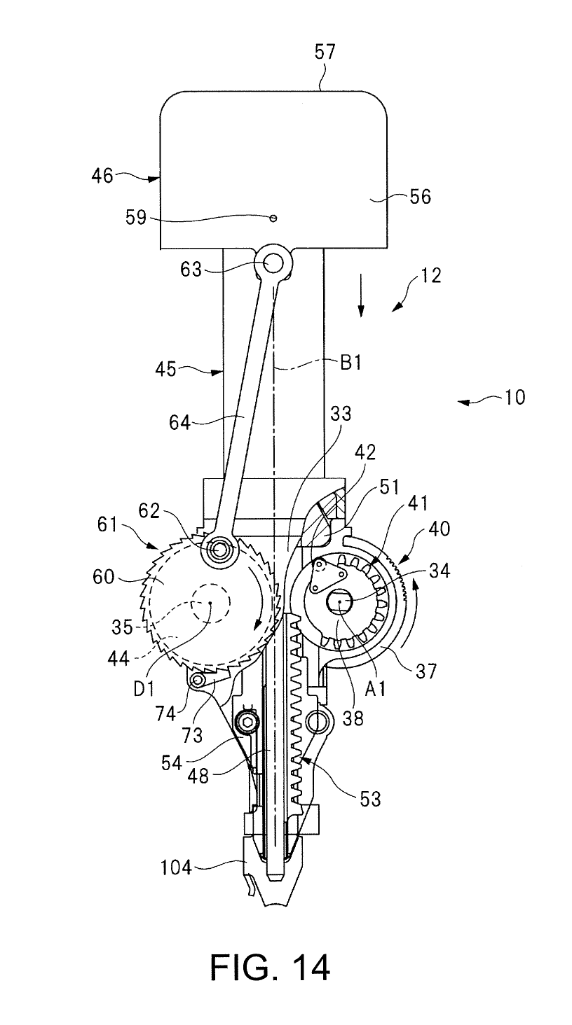

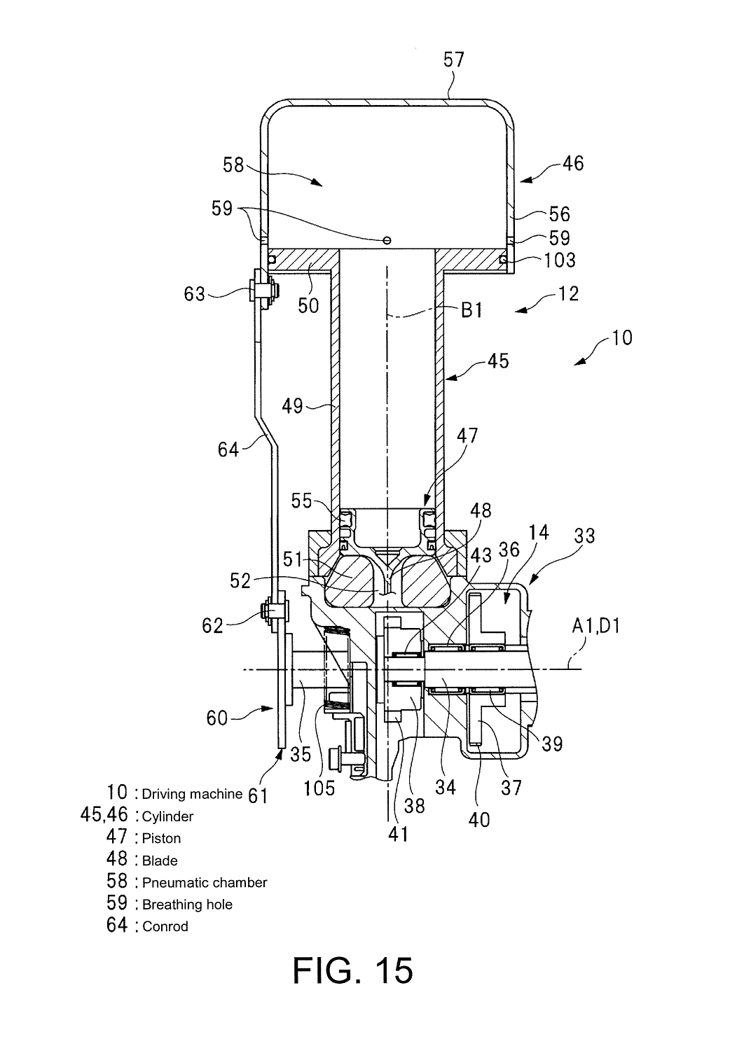

FIG. 14 is a side view as viewed from the direction A in FIG. 13, and a part thereof is shown in sectional view. A rotational driving force of the electric motor 13 is transmitted to a drive shaft 34 and a driven shaft 35 through an output of the decelerator 27. Herein, two power transmission paths, i.e., a first power transmission path driven by rotation of the driven shaft 35 and a second power transmission path driven by rotation of the drive shaft 34, are provided. The first power transmission path is movable in the up-down direction of the movable second cylinder 46 using a gear 44 rotated by the driven shaft 35. The second power transmission path moves the blade 48 upward using a gear 41 rotated by the drive shaft 34, thereby moving the piston 47 (see FIG. 15) from the bottom dead point to the top dead point. While details thereof are described later, when the electric motor 13 is rotated in the normal direction, the power is only transmitted to the drive shaft 34 so that only the gear 41 rotates; when the electric motor 13 is rotated in the opposite direction, the power is only transmitted to the driven shaft 35 so that only the gear 44 rotates. Accordingly, by setting the rotational direction of the electric motor 13, whether the power is transmitted toward the first power transmission path or toward the second power transmission path can be alternatively selected.

The drive shaft 34 is arranged concentrically with the output shaft 24 (see FIG. 1) of the electric motor 13 and is rotatable about the axis line A1. A rotating body 37 and the rotating body 38 are attached to the drive shaft 34. A gear 40 is provided on an outer peripheral surface of the rotating body 37, and a rotational force is transmitted toward the driven shaft 35 by the gear 40. The gear 40 is provided on the outer peripheral surface of the rotating body 37. A one-way clutch 39 (see FIG. 15) is provided connecting or blocking the power transmission path between the rotating body 37 and the drive shaft 34. When the drive shaft 34 rotates in the counterclockwise direction in FIG. 14, a rotational force of the drive shaft 34 is transmitted to the rotating body 37. Even if the drive shaft 34 rotates in the clockwise direction in FIG. 14, the one-way clutch 39 does not transmit the rotational force of the drive shaft 34 to the rotating body 37. That is, the one-way clutch 39 connects or blocks the power transmission path between the drive shaft 34 and the driven shaft 35 according to the rotational direction of the drive shaft 34.

The gear 41 is provided within a predetermined angle range on the outer peripheral surface of the rotating body 38. In addition, in the rotational direction of the rotating body 38, a roller 42 is provided at a part where the gear 41 is not provided. A part of an outer peripheral surface of the roller 42 is arranged outside the outer peripheral surface of the rotating body 38. The roller 42 is rotatably supported.

The gear 44 is provided on the driven shaft 35. The gear 44 meshes with the gear 40. The blade 48 is arranged along the center line B1 and is movable within a shaft hole 52 (see FIG. 15). A rotation stopper 73 being a holding member that restricts rotation of a rotating body 60 is provided on the casing 33. The rotation stopper 73 is swingable about a support shaft 74. By meshing with a gear 61, the rotation stopper 73 prevents the rotating body 60 from rotating in the counterclockwise direction in FIG. 14 and allows the rotating body 60 to rotate in the clockwise direction. That is, the gear 61 and the rotation stopper 73 constitute a ratchet mechanism. The rack 53 is provided on the blade 48 in the length direction. The gear 41 is capable of meshing with or being detached from the rack 53. The casing 33 has the cylindrical nose portion 54, and the blade 48 is movable in the nose portion 54.

The nose portion 54 is exposed outside the cover 100 (see FIG. 13). The pushrod 104 is provided on the nose portion 54. The pushrod 104 is movable with respect to the nose portion 54 in a predetermined range in the direction along the center line B1. The pushrod 104 is pressed and stopped in the direction along the center line B1 by the force of the compression spring 105 (see FIG. 15). When the pushrod 104 is pressed against the object, the pushrod 104 moves in the direction of the center line B1 against the force of the compression spring 105 (see FIG. 15) and then stops.

FIG. 15 is a front sectional view of the driving machine shown in FIG. 13. As shown in FIG. 15, the striking mechanism 12 includes the first cylinder 45, the second cylinder 46, the piston 47 and the blade 48. The cylinders 45 and 46 are arranged within the cover 100 (see FIG. 13). The cylinder 45 includes a cylindrical portion 49, and an outward-facing flange 50 continuous with the cylindrical portion 49. The center line B1 of the cylindrical portion 49 intersects with the axis line A1 at a substantially right angle, and a first end portion (lower end portion) of the cylindrical portion 49 in the direction along the center line B1 is fixed to the casing 33. A part of a power transmission mechanism 14 is provided in the casing 33. The power transmission mechanism 14 includes the drive shaft 34 and the driven shaft 35 arranged parallel to each other. The drive shaft 34 is rotatably supported by the casing 33 through a bearing 36. The drive shaft 34 is arranged concentrically with the output shaft 24 and is rotatable about an axis line D1. In addition, the rotating bodies 37 and 38 are attached to the drive shaft 34. The rotating body 37 is arranged between the rotating body 38 and the decelerator 27 in a direction along the axis line A1. The rotational direction of the drive shaft 34 is the same as the rotational direction of the rotor 19 of the electric motor 13. A one-way clutch 43 is provided between the rotating body 38 and the drive shaft 34. When the drive shaft 34 rotates in the clockwise direction in FIG. 14, the one-way clutch 43 transmits the rotational force of the drive shaft 34 to the rotating body 38; when the drive shaft 34 rotates in the counterclockwise direction, the one-way clutch 43 does not transmit the rotational force of the drive shaft 34 to the rotating body 38.

The gear 40 is provided on the outer peripheral surface of the rotating body 37. The one-way clutch 39 is provided connecting or blocking the power transmission path between the rotating body 37 and the drive shaft 34. When the drive shaft 34 rotates in the counterclockwise direction in. FIG. 2, the one-way clutch 39 transmits the rotational force of the drive shaft 34 to the rotating body 37. Even if the drive shaft 34 rotates in the clockwise direction in FIG. 14, the one-way clutch 39 does not transmit the rotational force of the drive shaft 34 to the rotating body 37. That is, the one-way clutch 39 connects or blocks the power transmission path between the drive shaft 34 and the driven shaft 35 according to the rotational direction of the drive shaft 34.

The flange 50 is provided on a second end portion (upper end portion) of the cylindrical portion 49 in the direction along the center line B1 being an axis line of the cylinder 45. In addition, an annular damper 51 integrally formed of a rubber-like elastic body is provided between the cylindrical portion 49 and the casing 33. The damper 51 includes the shaft hole 52.

The piston 47 is reciprocally movable in the cylindrical portion 49 in the direction along the center line B1, and the seal member 55 is attached to the outer peripheral surface of the piston 47. In addition, the shaft-shaped blade 48 is connected to or fixed to the piston 47. The cylinder 46 includes a cylindrical portion 56 and a circular plate portion 57 continuous with the cylindrical portion 56. The flange 50 is arranged in the cylindrical portion 56, and the cylinder 46 is movable with respect to the cylinder 45 in the direction along the center line B1. A seal member 103 is attached to an outer peripheral surface of the flange 50, and a pneumatic chamber 58 is formed in the cylinder 46. The pneumatic chamber 58 communicates with the inside of the cylinder 45. A breathing hole 59 is provided penetrating the cylindrical portion 56 in the radial direction. The breathing hole 59 connects the inside and outside of the pneumatic chamber 58. The seal members 55 and 103 airtightly seal the pneumatic chamber 58. The air being a compressible fluid goes into and out of the pneumatic chamber 58 through the breathing hole 59.

The rotating body 60 having the gear 61 provided on its outer peripheral surface is attached to a part of the driven shaft 35 that is exposed outside the casing 33. The rotating body 60 is rotatable about the axis line D1 along with the driven shaft 35. On the rotating body 60, a support shaft 62 is provided in a position eccentric from the axis line D1. In addition, a support shaft 63 is provided on the cylinder 46. A conrod 64 is provided connecting the rotating body 60 and the cylinder 46. The conrod 64 is rotatably attached to the support shafts 62 and 63, and constitutes, along with the rotating body 60, an opening and closing mechanism that opens a ventilation passage.

When the trigger 72 is not being operated, the electric motor 13 is stopped. In addition, the cylinder 46 is stopped in the initial position in FIG. 14 and FIG. 15. When the cylinder 46 is stopped in the initial position, the pneumatic chamber 58 is connected to outside of the pneumatic chamber 58 through the breathing hole 59. That is, the initial pressure in the pneumatic chamber 58 and the cylinder 45 is the same as atmospheric pressure. In addition, the piston 47 contacts the damper 51 and then stops, and the gear 41 does not mesh with the rack 53 (see FIG. 14).

In the preparation step (first step) before performing striking, the operator operates the rotational direction switching switch 68 (see FIG. 5), so as to set the rotational direction of the drive shaft 34 to the counterclockwise direction in FIG. 14, and to apply an operating force to the trigger 72. Moreover, in the first step, the pushrod 104 may not be pressed against the object, but may not move unless being pressed. Thereupon, when the trigger switch 71 is switched on, the electric motor 13 rotates. Herein, the drive shaft 34 is rotated in the counterclockwise direction in FIG. 14 by the rotational force of the electric motor 13. The rotational force of the drive shaft 34 is transmitted to the driven shaft 35 through the one-way clutch 39, and the driven shaft 35 and the rotating body 60 integrally rotate in the clockwise direction in FIG. 14.

When the rotating body 60 rotates in the clockwise direction in FIG. 14, a rotational force of the rotating body 60 is transmitted to the cylinder 46 through the conrod 64, and the cylinder 46 operates in a direction (shooting direction) of arrow B along the center line B1, and lowers in a direction approaching the casing 33 from the initial position shown in FIG. 14 and FIG. 15. When the cylinder 46 lowers and the breathing hole 59 reaches between the seal member 103 and the casing 33 in the direction along the center line B1, the flange 50 blocks the breathing hole 59 and the pneumatic chamber 58. That is, the breathing hole 59 is closed, and the pneumatic chamber 58 and the cylinder 45 become airtight. Hence, the pressure in the pneumatic chamber 58 and the cylinder 45 increases in the lowering stroke of the cylinder 46. As a result, the pressure in the pneumatic chamber 58 and the cylinder 45 becomes a first pressure higher than atmospheric pressure.

Then, when a rotational angle of the driven shaft 35 changes from the position in FIG. 14 in which the rotation starts to the position in which a predetermined angle of less than 180 has been rotated, the controller 66 stops the electric motor 13. That is, the cylinder 46 stops in the vicinity of (the bottom dead point) where the circular plate portion 57 is about to contact the flange 50 of the cylinder 45. The circular plate portion 57 of the cylinder 46 receives the pressure of the pneumatic chamber 58, and the cylinder 46 is energized in a rising direction along the center line B1. The energizing force received by the cylinder 46 is transmitted to the rotating body 60 through the conrod 64. That is, the rotating body 60 receives a rotational force in the counterclockwise direction in FIG. 14.

Next, the operator operates the rotational direction switching switch 68 in order to perform the striking step (second step), so as to set the rotational direction of the electric motor 13 opposite that set in the first step. The electric motor 13 is stopped at a time point when the rotational direction is set. Then, in the state where the pushrod 104 is pressed against the object, the electric motor 13 rotates when the trigger 72 is operated, and the drive shaft 34 rotates in the clockwise direction in FIG. 14. When the drive shaft 34 rotates in the clockwise direction in FIG. 8, the one-way clutch 39 does not transmit the rotational force of the drive shaft 34 to the driven shaft 35.

When the drive shaft 34 rotates in the clockwise direction in FIG. 14, the gear 41 meshes with the rack 53, and the rotational force of the drive shaft 34 is converted to a force causing the piston 47 to rise. Accordingly, the pressure in the pneumatic chamber 58 and the cylinder 45 further increases. That is, the pressure in the pneumatic chamber 58 and the cylinder 45 becomes a second pressure higher than the first pressure. Then, when the piston 47 reaches the top dead point closest to the circular plate portion 57, the gear 41 is separated from the rack 53.

Thereupon, the piston 47 is rapidly lowered toward the damper 51 by the air pressure in the pneumatic chamber 58 and the cylinder 45, and the blade 48 strikes the nail 11 to drive the nail 11 into the object. Then, the piston 47 collides with the damper 51 and then stops. The electric motor 13 rotates even after the gear 41 has been separated from the rack 53. When the gear 41 reaches a predetermined position, i.e., before the gear 41 meshes with the rack 53, the electric motor 13 stops. After that, by the operator separating the pushrod 104 from the object, the driving operation of the nail 11 terminates.

When the operator presses the pushrod 104 against the object to pull the trigger 72 in a next driving position, the electric motor 13 rotates to rotate the rotating body 38 in the clockwise direction in FIG. 14, the gear 41 meshes with the rack 53, and the piston 47 rises. Thereby, the nail 11 is driven by the same action as above.

Moreover, in a state where the nail 11 is not set in the magazine 16 in the driving machine 10, when the piston 47 is stopped, the operator grips the rotation stopper 73 by hand and rotates the rotation stopper 73 in the clockwise direction in FIG. 14, and the rotation stopper 73 is separated from the gear 61. Thereby, the pressure in the pneumatic chamber 58 and the cylinder 45 can be reduced.

As described above, by connecting the pneumatic chamber 58 to the breathing hole 59, the pressure in the pneumatic chamber 58 and the cylinder 45 can be reduced. Thus, in cases where the nail 11 clogs, the nail 11 can be easily removed. In addition, during storage of the driving machine 10, since the air pressure of the pneumatic chamber 58 can be released, there is no need to provide a seal member for maintaining high pressure of the air chamber.

### Example 4

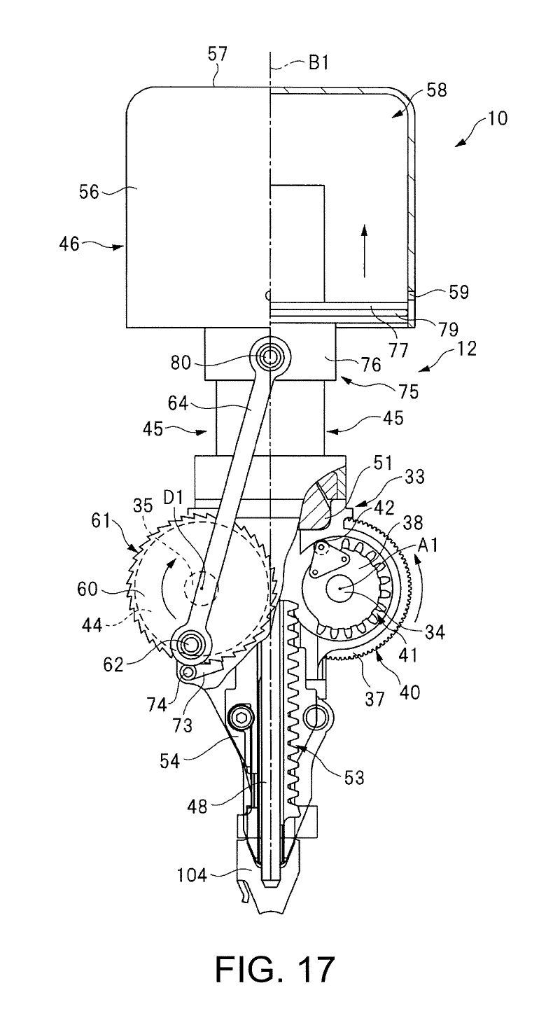

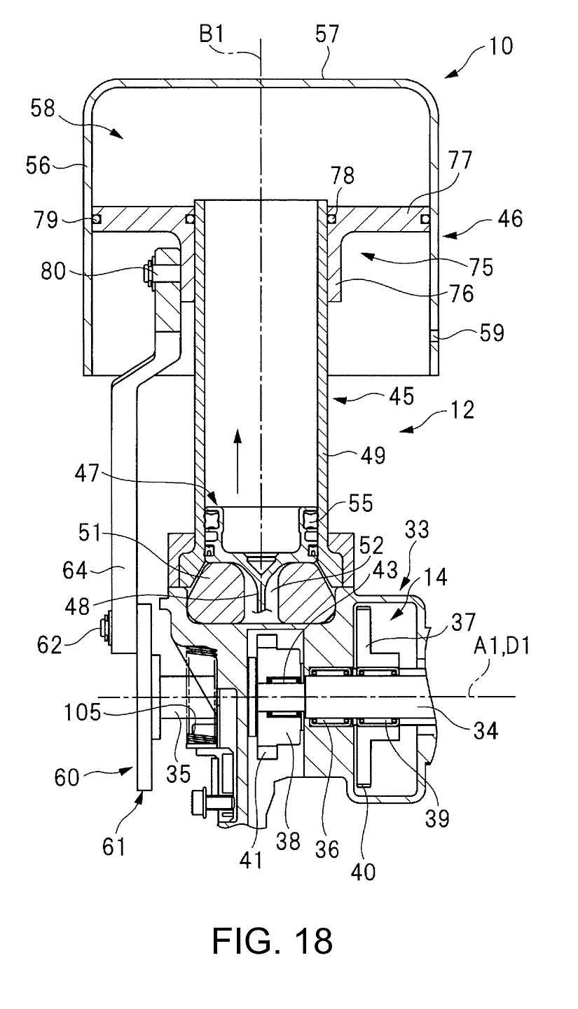

A driving machine corresponding to the fourth example is shown in FIG. 17 to FIG. 18. The driving machine 10 in FIG. 17 includes the same structure and the same elements as those of the driving machine 10 shown in the third example. The cylinder 45 has a cylindrical shape. The flange 50 explained in Example 3 is not provided, and instead a partition 75 attached to the cylinder 45 is provided. The partition 75 includes a cylindrical portion 76 movable along an outer peripheral surface of the cylindrical portion 49 of the cylinder 45, and an outward-facing flange 77 continued from the cylindrical portion 76. An outer diameter of the flange 77 is less than an inner diameter of the cylindrical portion 56. The partition 75 is movable with respect to the cylinder 45 and the cylinder 46 in the direction along the center line B1.

A seal member 78 is attached to an inner peripheral surface of the cylindrical portion 76, and the seal member 78 airtightly seals between the outer peripheral surface of the cylindrical portion 49 and the partition 75. In addition, a seal member 79 is attached to an outer peripheral surface of the flange 77. The seal member 79 airtightly seals between an inner peripheral surface of the cylindrical portion 56 and the flange 77. Furthermore, a support shaft 80 is provided on an outer peripheral surface of the cylindrical portion 76, and the conrod 64 is rotatably connected to the support shaft 80. That is, the rotating body 60 and the partition 75 are connected to each other in a manner capable of transmitting power through the conrod 64. The arrangement range of the support shaft 80 and the conrod 64 in the radial direction of the center line B1 is less than the inner diameter of the cylindrical portion 56.

First of all, the first step of increasing the air pressure of the pneumatic chamber 58 is performed. In the second step, the air pressure of the pneumatic chamber 58 is further increased and the nail 11 is struck. The operator operates the rotational direction switching switch 68 to switch the rotational direction of the electric motor 13, and sets the rotational direction of the drive shaft 34 in the first step to the counterclockwise direction in FIG. 17.

The partition 75 is stopped in an initial position in FIG. 17 before the drive shaft 34 starts rotating. When the partition 75 is stopped in the initial position, the pneumatic chamber 58 is connected to outside of the pneumatic chamber 58 through the breathing hole 59. That is, the pressure in the pneumatic chamber 58 and the cylinder 45 is the same as atmospheric pressure. In addition, the piston 47 contacts the damper 51 and is then stopped.

Then, when the operating force is applied to the trigger 72 in a state where the pushrod 104 is not being pressed against the object, the electric motor 13 rotates, and the drive shaft 34 rotates in the counterclockwise direction in FIG. 17. Thereupon, the rotating body 60 rotates in the clockwise direction in FIG. 17 on the same principle as that of the driving machine 10 of Example 3. The rotational force of the rotating body 60 is converted into an operation force in the direction along the center line B1 by the conrod 64. Hence, the partition 75 rises along the center line B1. When the partition 75 rises and the seal member 79 reaches between the breathing hole 59 and the circular plate portion 57 in the direction along the center line B1, the pneumatic chamber 58 and the cylinder 45 become airtight. Hence, with the rise of the partition 75, the pressure in the pneumatic chamber 58 and the cylinder 45 increases. That is, the pressure in the pneumatic chamber 58 and the cylinder 45 becomes the first pressure higher than atmospheric pressure.

Then, when the rotational angle of the driven shaft 35 changes from the position in FIG. 17 in which the rotation starts to the position in FIG. 18 in which a predetermined angle of less than 180 has been rotated, the electric motor 13 is stopped. That is, the partition 75 stops before reaching the top dead point. The flange 77 of the partition 75 receives the pressure of the pneumatic chamber 58, and the partition 75 is energized in the direction approaching the casing 33 along the center line B1. The energizing force received by the partition 75 is transmitted to the rotating body 60 through the conrod 64. That is, the rotating body 60 receives a rotational force in the counterclockwise direction in FIG. 17.

Next, the operator operates the rotational direction switching switch 68 in order to perform the second step, and switches the rotational direction of the electric motor 13. The operation in the second step hereafter is the same as that in the third example.

In the driving machine 10 of the fourth example, even if the partition 75 rises and lowers in the direction along the center line B1, the whole length of the driving machine 10 in the direction along the center line B1 does not change. The whole length of the driving machine 10 is a height from the tip of the pushrod 104 to the upper end of the cylinder 45.

### Example 5

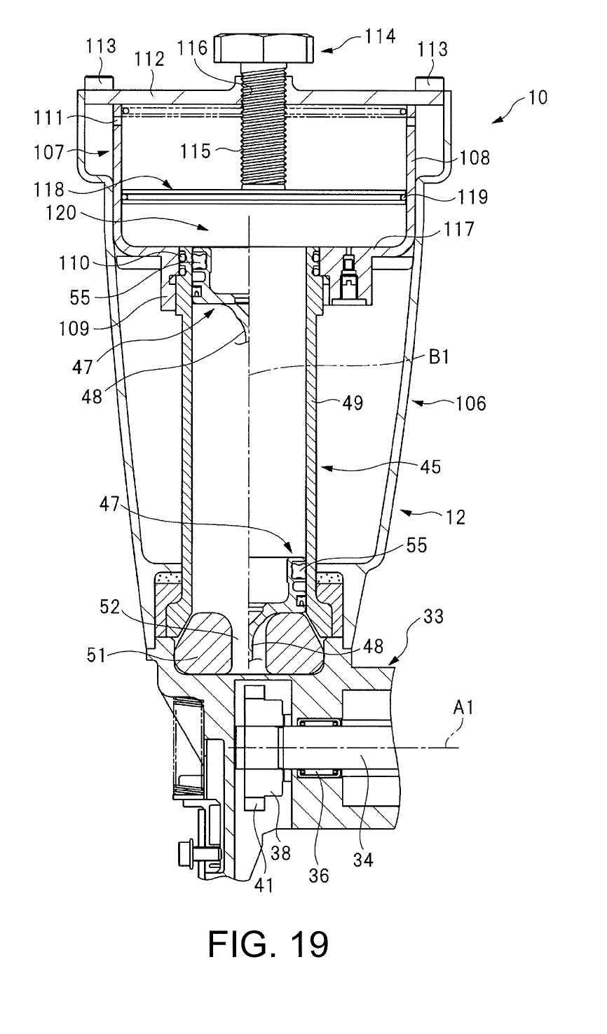

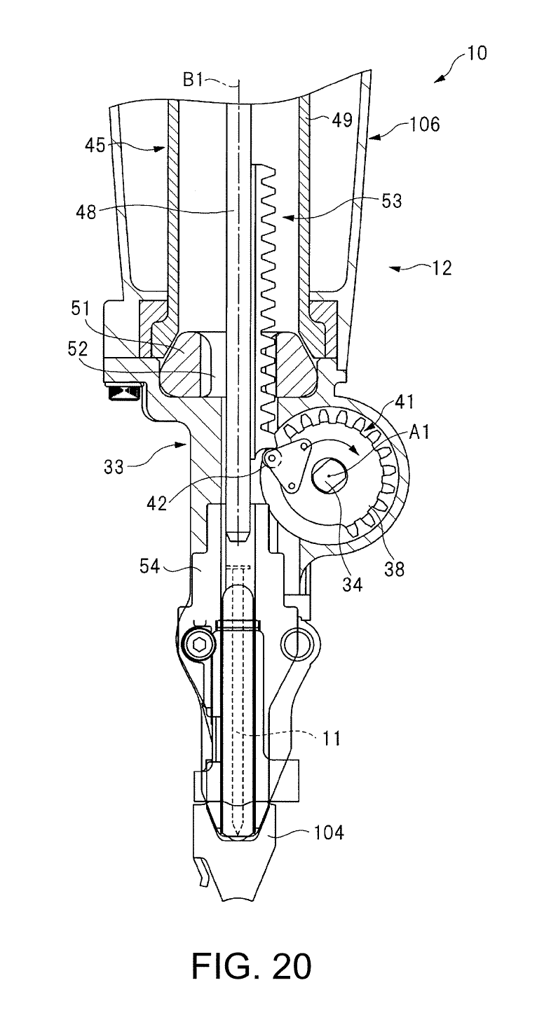

A driving machine corresponding to the fifth example of the present invention is shown in FIG. 19 and FIG. 20. The driving machine 10 shown in FIG. 19 can use the electric motor 13, the decelerator 27, the rotating body 38, the piston 47, the roller 42, the blade 48 and the cylinder 45 having the same structures as those in the driving machine 10 of the fourth example. However, the driving machine 10 in FIG. 19 does not include the first power transmission path part (the driven shaft 35, the rotating body 37, the one-way clutch 43 and the conrod 64) of the fourth example. The driving machine 10 instead includes an outer cylinder 106 fixed to the casing 33, and the cylinder 45 is arranged in the outer cylinder 106. An inner cylinder 107 is provided in the outer cylinder 106. The cylinder 45 is arranged between the inner cylinder 107 and the casing 33 in the direction along the center line B1.

The inner cylinder 107 includes a large-diameter portion 108 and a small-diameter portion 109. The small-diameter portion 109 is arranged between the large-diameter portion 108 and the casing 33 in the direction along the center line B1. An inner diameter of the large-diameter portion 108 is larger than an inner diameter of the small-diameter portion 109. Furthermore, the inner cylinder 107 has a connecting portion 117 connecting the large-diameter portion 108 and the small-diameter portion 109. The connecting portion 117 has an annular shape. A breathing hole 111 is provided penetrating the large-diameter portion 108 in the radial direction. An end portion of the cylinder 45 in the length direction is fixed to the small-diameter portion 109. A seal member 110 is provided sealing between an outer peripheral surface of the cylinder 45 and an inner peripheral surface of the small-diameter portion 109.

A holder 112 is fixed to the outer cylinder 106. A screw member 113 is provided fixing the holder 112 to the outer cylinder 106. By the holder 112, the inner cylinder 107 is positioned and fixed to the outer cylinder 106 in the direction along the center line B1. The breathing hole 111 is connected to outside of the outer cylinder 106 through inside of the outer cylinder 106.

In addition, a plunger 114 is attached to the holder 112. The plunger 114 is a mechanism using a screw member, and a male thread of a shaft portion 115 of the plunger 114 is formed. A female screw hole 116 is provided in the holder 112, and the shaft portion 115 is inserted into the female screw hole 116. The operator can manually rotate the plunger 114 in normal and reverse directions, and the plunger 114 is movable in the direction along the center line B1 when rotated in either direction. When the rotational direction of the plunger 114 differs, the direction in which the plunger 114 moves along the center line B1 differs.

A movable partition 118 is attached to a tip of the shaft portion 115. The movable partition 118 is arranged in the large-diameter portion 108. The movable partition 118 is a circular plate rotatable about the center line B1 with respect to the shaft portion 115. An outer diameter of the movable partition 118 is less than the inner diameter of the large-diameter portion 108, and an annular seal member 119 is attached to an outer peripheral surface of the movable partition 118. In the large-diameter portion 108, a pneumatic chamber 120 is formed from a space between the movable partition 118 and the connecting portion 117 and across in the cylinder 45. The seal members 55, 110 and 119 airtightly seal the pneumatic chamber 120. The breathing hole 111 connects the inside and outside of the pneumatic chamber 120.

In FIG. 20, the configuration and operation of the second power transmission path part including the rotating body 38 are the same as those in the third to fourth examples. However, the rotational direction switching switch 68 for switching the rotational direction of the electric motor 13 is not provided since it is unneeded.

When using the driving machine 10, before pressing the pushrod 104 against the object, the operator performs the first step of increasing air pressure of the pneumatic chamber 120. In the second step, the operator further increases the air pressure of the pneumatic chamber 120, and presses the pushrod 104 against the object to strike the nail 11. The drive shaft 34 is stopped before the operator performs the first step. In addition, as shown on the right side of the center line B1 in FIG. 14, the piston 47 contacts the damper 51. Furthermore, the movable partition 118 is stopped in a position shown in chain double-dashed lines in FIG. 14. That is, the pneumatic chamber 120 is connected to outside of the outer cylinder 106 through the breathing hole 111, and pressure of the pneumatic chamber 120 is the same as atmospheric pressure.

In the first step, the operator rotates the plunger 114 in a predetermined direction using a spanner or the like, so as to move the plunger 114 in the direction along the center line B1. In the first step, the plunger 114 lowers in a direction approaching the cylinder 45. Thereupon, the movable partition 118 blocks the pneumatic chamber 120 and the breathing hole 111, and the pressure of the pneumatic chamber 120 increases with movement of the movable partition 118. The operator stops the movable partition 118 in a predetermined position in the direction along the center line B1. Hence, the pressure of the pneumatic chamber 120 is maintained at the first pressure higher than atmospheric pressure.

The operation in the second step is the same as that in the third and the fourth examples. In the driving machine 10 in the fifth example, by rotating the plunger 114 in a direction opposite that mentioned above and moving the plunger 114 in the direction of the center line B1 in a direction away from the cylinder 45, the pressure of the pneumatic chamber 120 can be reduced. When the movable partition 118 rises in the direction away from the cylinder 45 along with the plunger 114, the seal member 119 reaches between the breathing hole 111 and the holder 112 in the direction of the center line B1, and the breathing hole 111 is connected to the pneumatic chamber 120. Hence, the air pressure of the pneumatic chamber 120 is reduced to become the same as atmospheric pressure. Accordingly, the driving machine 10 of the fifth example obtains the same effects as those obtained by the driving machine 10 of Example 4.

The driving machine of the present invention is not limited to the above embodiments but can be modified in various ways without departing from the gist thereof. For example, the motor that transmits power to the drive shaft may be, in addition to an electric motor, an engine, a hydraulic motor, or a pneumatic motor. The electric motor may be either a brushed motor or a brushless motor. A power supply for the electric motor may be either a DC power supply or an AC power supply. Furthermore, compressed air having an initial pressure higher than atmospheric pressure and equal to or lower than the first pressure may be filled into the pneumatic chamber 58 and the cylinder 45.

In addition, in the driving machine 10 in each drawing for explaining each example, the center line B1 is shown as an up-down direction, i.e., vertical direction. However, the driving machine 10 can be used with the center line B1 being inclined with respect to the vertical direction. Furthermore, the object to be driven by the driving machine includes, in addition to a shaft-shaped nail, a lateral U-shaped nail. In addition, the shaft-shaped nail includes a nail having a head or a nail having no head. Furthermore, the first pressure and the second pressure in the present invention are not fixed values but vary depending on conditions such as an operation amount of a movable member, pressure receiving area and so on.

In the third and fourth driving machine 10, the rotational direction of the rotor 19 of the electric motor 13 is switched to switch the rotational direction of the drive shaft 34. In contrast, by providing a rotational direction switching mechanism in the power transmission path between the electric motor 13 and the drive shaft 34 and controlling the rotational direction switching mechanism, it is possible to switch the rotational direction of the drive shaft 34 without switching the rotational direction of the electric motor 13.

### DESCRIPTION OF THE REFERENCE NUMERALS

10: driving machine; 11: nail (stopper); 11a: head portion; 12: striking mechanism; 13: electric motor; 14: power transmission mechanism; 15: storage battery; 16: magazine; 17: motor housing; 18: stator; 19: rotor; 21: coil; 24: output shaft; 27: decelerator; 33: casing; 34: drive shaft; 35: driven shaft; 36: bearing; 37: rotating body; 38: rotating body; 39: one-way clutch; 40: gear; 41: gear; 42: roller; 43: one-way clutch; 44: gear; 45: cylinder; 46: cylinder; 47: piston; 48: blade; 48b: tip; 49: cylindrical portion; 50: flange; 51: damper; 52: shaft hole; 53: rack; 53a: upper end tooth; 53b: lower end tooth; 54: nose portion; 55: seal member; 56: cylindrical portion; 57: circular plate portion; 58: pneumatic chamber; 59: breathing hole; 60: rotating body; 61: gear; 62: support shaft; 63: support shaft; 64: conrod; 65: inverter circuit; 66: controller; 67: phase detection sensor; 68: rotational direction switching switch; 71: trigger switch; 72: trigger (trigger lever); 73: rotation stopper; 74: support shaft; 75: partition; 76: cylindrical portion; 77: flange; 78, 79: seal member; 80: support shaft; 81: control circuit substrate; 82a, 82b: bearing; 83: inverter circuit substrate; 84: switching element; 100: cover; 101: grip; 103: seal member; 104: pushrod; 105: compression spring; 106: outer cylinder; 107: inner cylinder; 108: large-diameter portion; 109: small-diameter portion; 110: seal member; 111: breathing hole; 112: holder; 113: member; 114: plunger; 115: shaft portion; 116: hole; 117: connecting portion; 118: movable partition; 119: seal member; 120: pneumatic chamber; 121: detection sensor; 201: driving machine; 202: main body housing; 202b: through hole; 203: grip; 204: mounting portion; 233: casing; 234: drive shaft; 235: pin; 236: off switch; 236a: plunger; 237: operating lever; 238: rotating body; 241: pinion; 241a: tip tooth; 241b: rear end tooth; 245: cylinder; 245a: opening portion; 245c: male thread; 267: washer; 248: cylinder chamber; 249: pneumatic chamber; 250: pressure accumulation container; 251: container main body portion; 251b: through hole; 252: cylindrical portion; 254: nose portion; 255: flange portion; 255c: female thread; 256: shooting path; 257: magnetic sensor; 260: external air intake valve; 261: switching lever; 261a: through hole; 262: cylindrical sleeve; 262a: external air intake passage; 262b: spline groove; 263: collar; 264: steel ball; 265: selector; 265a: communicating path; 265b: cylindrical depression; 265c: communicating path; 265d: outer peripheral groove; 265e: stepped portion; 266: metal; 270: cushion material; 271 to 273: O-ring; 301: driving machine; 302: main body housing; 302c: through hole; 303: grip portion; 349: pneumatic chamber; 350: pressure accumulation container 350; 351: container main body portion; 351c: large-diameter portion; 351d: small-diameter portion; 353: through hole; 355: flange portion; 360: leak valve; 361: (leak) plunger holder; 361c: horizontal hole; 363: ring; 365: discharge pipeline; 365a: tip part; 370: (leak) plunger; 371: communicating path; 372: narrowed part; 374: communicating path; 375: wide groove; 376 to 377: O-ring; 379: coil spring; 381: ball; 382: pusher; 383: coil spring; 384: metal plate; 385: push button; 386: retaining ring; 449: pneumatic chamber; 450: pressure accumulation container; 451: container main body portion; 451b: through hole portion; 455: flange portion; 460: electromagnetic valve; 461: discharge pipe; 462: communicating path; 463: valve; 464: solenoid actuator; 465: housing; 466: coil; 467: iron core; 468: O-ring

1. (canceled)

2. A driving machine comprising: a housing; a cylinder provided within the housing; a pneumatic chamber spatially connected to the cylinder; a piston reciprocally movably provided in the cylinder; a blade attached to the piston and striking a stopper; and a moving mechanism moving the piston between a top dead point and a bottom dead point, the driving machine driving the stopper by a repulsive force of compressed air, wherein a valve for introducing external air to the pneumatic chamber is provided, a pressure accumulating mode is provided in which, in a state where the stopper is not loaded in a shooting path of the blade, by moving the piston from the top dead point to the bottom dead point in the cylinder, the external air is introduced, and a striking mode is provided in which, the piston is moved from the bottom dead point to the top dead point in the cylinder by the moving mechanism, and then moved from the top dead point toward the bottom dead point by pressure of the pneumatic chamber, thereby driving the stopper.

3. The driving machine according to claim 2, wherein in the striking, the piston is moved by the moving mechanism from the bottom dead point to the top dead point in the cylinder, and in the pressure accumulating mode, the piston is reciprocally moved by the moving mechanism in a range from the bottom dead point to before the top dead point so as to perform a pressurization operation.

4. The driving machine according to claim 3, wherein the movement of the piston in the cylinder in the pressure accumulating mode is driven by a motor, and the motor is controlled by a control portion.

5. The driving machine according to claim 4, wherein the valve comprises an external air intake passage, a check valve allowing only inflow of air from the external air toward the pneumatic chamber, and a switching lever performing opening and closing of the external air intake passage, wherein intake of the external air is allowed or inhibited by operation of the switching lever.

6. The driving machine according to claim 5, wherein the moving mechanism comprises the motor, a rotating body rotated by a driving force of the motor and having a pinion that moves the blade, and a rack formed on the blade, wherein the pinion meshes with the rack until immediately before the piston reaches the top dead point from the bottom dead point, and the meshing between the pinion and the rack is released when the piston reaches the top dead point.

7. The driving machine according to claim 6, wherein the motor is a brushless DC motor, and the control portion drives the motor so as to repeat normal rotation and reverse rotation of the pinion in a state where the meshing between the rack and the pinion is not released in the pressure accumulating mode.

8. The driving machine according to claim 4, comprising a stopper sensor detecting whether the stopper to be struck has been mounted or not, so that the pressure accumulating mode cannot be executed when the stopper remains.

9. The driving machine according to claim 8, wherein when the piston is moved by the motor in the pressure accumulating mode, the control portion monitors a current value flowing to the motor, and terminates the operation in the pressure accumulating mode when a set current value is exceeded.

10. The driving machine according to claim 7, wherein a pressure sensor is provided detecting the pressure of the pneumatic chamber, and when the piston is moved by the motor in the pressure accumulating mode, the control portion monitors the pressure and terminates the operation in the pressure accumulating mode when a set pressure is exceeded.

11. The driving machine according to claim 7, wherein the control portion counts a number of times the piston is reciprocally moved by the motor in the pressure accumulating mode, and terminates the operation in the pressure accumulating mode when a counted value reaches a predetermined number of times.

12. The driving machine according to claim 4, comprising a switch mechanism having a trigger lever, and a pushrod to be brought into contact with a driven material, wherein the motor is activated when the trigger lever is operated in a state where the pushrod is pressed.

13. The driving machine according to claim 2, wherein a leak valve for allowing air to escape to the outside when the pressure in the pneumatic chamber exceeds a predetermined value is provided in the pneumatic chamber.

14. (canceled)

15. The driving machine according to claim 13, wherein a manual leak mechanism capable of arbitrarily releasing the pressure of the pneumatic chamber is provided in the leak valve.

16. The driving machine according to claim 13, wherein the leak valve comprises a ball closing an air passage, a leak plunger holding the ball and forming the air passage, a spring pressing the ball against an outlet of the air passage, a leak plunger holder for holding the leak plunger so as to fix it to the housing, and a push button causing the leak plunger holder to move to release a state where the ball abuts against the outlet.

17. The driving machine according to claim 2, comprising: a first compression mechanism increasing pressure of the pneumatic chamber; and a second compression mechanism increasing pressure in the cylinder.
